(19) United States
(12) Patent Application Publication
(10) Pub. No.: US 2020/0292428 A1
(43) Pub. Date: Sep. 17, 2020

(54) STATE DETERMINATION APPARATUS, STATE DETERMINATION METHOD, AND COMPUTER-READABLE RECORDING MEDIUM

(71) Applicant: NEC CORPORATION, Tokyo (JP)

(72) Inventor: Hiroshi IMAI, Tokyo (JP)

(73) Assignee: NEC CORPORATION, Tokyo (JP)

(21) Appl. No.: 16/646,444

(22) PCT Filed: Sep. 12, 2018
(86) PCT No.: PCT/JP2018/033859

§ 371 Date: Mar. 11, 2020

(30) Foreign Application Priority Data
Sep. 12, 2017 (JP) 2017-174805

(51) Int. Cl. G01N 3/08

(52) U.S. Cl. CPC G01N 3/08; G01N 2203/0062

(57) ABSTRACT

A degradation state determination apparatus 100 is an apparatus for determining the state of a structure, and includes a measurement unit 10 configured to measure a deflection amount and a surface displacement amount of the structure, a statistical processing unit 20 configured to executes statistical processing using the measured deflection amount and surface displacement amount, and a degradation state determination unit 30 configured to determine the degradation state of the structure based on the result of statistical processing.

### TECHNICAL FIELD

The present invention relates to a state determination apparatus and a state determination method for determining the degradation state of a structure, and further relates to a computer-readable recording medium that includes a program for realizing the same recorded thereon.

### BACKGROUND ART

It is known that, in concrete structures such as tunnels and bridges, defects occurring on the surface of structures, such as cracking, detachment, and internal hollowing, affect the soundness of the structures. Accordingly, these defects need to be accurately detected.

Defects of a structure, such as cracking, detachment, and internal hollowing, are detected through a visual inspection or a hammering test conducted by an inspector, and the inspector needs to approach the structure to conduct the inspection. For this reason, problems wise including an increase in work costs due to preparation of an environment in which work can be carried out in midair, a loss of economic opportunities due to traffic regulations conducted to configure the work environment, and so on, and there is demand for a method with which an inspector can remotely inspect a structure.

As a method of remotely inspecting a structure, for example, a method has been proposed in which a deflection amount distribution of a bridge, which is a structure, is measured based on an image obtained by imaging the bridge using an image capture device to detect an abnormality in the structure (e.g. see Patent Document 1). In addition, a method of measuring surface distortion of a structure to measure the degree of fatigue thereof (e.g. see Patent Document 2) has also been proposed.

### LIST OF RELATED ART DOCUMENTS

### Patent Document

Patent Document 1: Japanese Patent Laid-Open Publication No. 2016-84579

Patent Document 2: Japanese Patent Laid-Open Publication No. 2014-109536

### SUMMARY OF INVENTION

### Problems to be Solved by the Invention

The method disclosed in Patent Document 1 only uses the deflection amount distribution to detect an abnormality of a structure. In the method disclosed in Patent Document 2, the degree of fatigue of a structure is measured only by measuring surface distortion. That is to say, in the methods disclosed in Patent Documents 1 and 2, only one of the deflection amount and the surface distortion of a structure is used to conduct an inspection, and therefore the accuracy of these methods is problematic.

In contrast, an inspection can be conducted using both the deflection amount and the surface distortion of a structure by combining the method disclosed in Patent Document 1 and the ftp method disclosed in Patent Document 2, but in this case, an appropriate inspection is difficult if consideration is not given to the relationship therebetween. This is because the influence that appears as the deflection amount and the surface distortion differs depending on the state of a structure.

An example object of the invention is to solve the foregoing problems and provide a state determination apparatus, a state determination method, and a computer-readable recording medium that enable the degradation state of a structure to be properly determined using both a deflection amount and a surface distortion of the structure.

### Means for Solving the Problems

To achieve the above-stated example object, a degradation state determination apparatus according to an example aspect of the invention is a state determination apparatus for determining a state of a structure, including:
a measurement unit configured to measure a deflection amount and a surface displacement amount of the structure;
a statistical processing unit configured to perform statistical processing using the measured deflection amount and surface displacement amount; and
a degradation state determination unit configured to determine a degradation state of the structure based on a result of the statistical processing.

To achieve the above-stated example object, a degradation state determination method according to an example aspect of the invention is a state determination method for determining a state of a structure, comprising:
(a) a step of measuring a deflection amount and a surface displacement amount of the structure;
(b) a step of performing statistical processing using the measured deflection amount and surface displacement amount; and
(c) a step of determining a degradation state of the structure based on a result of the statistical processing.

Furthermore, to achieve the above-stated example object, a computer-readable recording medium according to an example aspect of the invention is a computer-readable recording medium that includes a program for determining a state of a structure using a computer recorded thereon, the program including instructions that cause the computer to carrying out:
(a) a step of measuring a deflection amount and a surface displacement amount of the structure;
(b) a step of performing statistical processing, using the measured deflection amount and surface displacement amount; and
(c) a step of determining a degradation state of the structure based on a result of the statistical processing.

### Advantageous Effects Of The Invention

As described above, according to the invention, the degradation state of a structure can be properly determined using both a deflection amount and a surface distortion of the structure.

### BRIEF DESCRIPTION OF THE DRAWINGS

FIG. 1 is a block diagram illustrating a schematic configuration of a state determination apparatus according to a first example embodiment of the invention.

FIG. 2 is a block diagram illustrating a configuration of the state determination apparatus according to the first example embodiment of the invention in detail.

FIG. 3 illustrates a deflection amount and a surface displacement amount of a structure that are to be determined in the first example embodiment of the invention.

FIG. 4 shows a displacement of a figure in a time-series image that occurs due to a deflection of a structure.

FIG. 5 shows an example of displacement vectors in a time-series image of a reference plane.

FIG. 6 illustrates a deflection amount δ(x) calculated in the first example embodiment of the invention.

FIG. 6(a) shows a beam that corresponds to a structure, and FIG. 6(b) shows an enlarged portion of the beam.

FIGS. 7(a) to 7(c) show the relationship between a deflection amount and a surface displacement amount of a structure, and show cases, where the state of the structure differs.

FIG. 8 illustrates a load applied to a bridge in the case where the structure is a bridge.

FIGS. 9(a) to 9(c) show examples of the relationship between a deflection amount and a surface displacement amount of the structure in the example in FIG. 8, and show cases where the state of the structure differs.

FIG. 10 is a flowchart showing operations of the state determination apparatus according to the first example embodiment of the invention.

FIG. 11(a) illustrates a deflection amount calculated in a second example embodiment of the invention using an example of a structure, and FIG. 11(b) shows a lower surface of the structure shown in FIG. 11(a).

FIGS. 12(a) to 12(c) show examples of degradation states of the lower surface of the structure, and show different states.

FIGS. 13(a) to 13(c) show examples of the relationship between a difference in a deflection amount and a surface displacement amount of a structure, and show cases where the state of the structure differs.

FIGS. 14(a) and 14(b) show other examples of the relationship between a difference in a deflection amount and a surface displacement amount of a structure, and show cases, where the state of the structure differs.

FIG. 15 is a flowchart showing operations of the state determination apparatus according to the second example embodiment of the invention.

FIG. 16 illustrates a deflection amount calculated in the third example embodiment of the invention using an example of a structure.

FIGS. 17(a) to 17(d) show the relationship between a deflection amount and a surface displacement amount of a bridge in the case where a vehicle passes over the bridge, with different parameters of the vertical axes.

FIG. 18(a) shows a temporal change in a time derivative of a deflection amount, FIG. 18(b) shows a temporal change in a surface displacement amount, and FIG. 18(c) shows a temporal change in a cross-correlation function.

FIGS. 19(a) to 19(c) illustrate states in the case where a slab of a bridge detaches. FIG. 19(a) shows the state of detachment in detail, FIG. 19(b) shows the lower surface of the detached slab, and FIG. 19(c) shows temporal changes in the deflection amount in a detached portion and a non-detached portion.

FIG. 20 illustrates a deflection amount calculated in the fourth example embodiment of the invention using an example of a structure.

FIG. 21 is a flowchart showing operations of the state determination apparatus according to the fourth example embodiment of the invention.

FIGS. 22(a) and 22(b) illustrate processing to determine the degradation state using two or more correlation coefficients in a first application example of the example embodiments of the invention.

FIG. 22(a) shows the case of using two correlation coefficients, and FIG. 22(b) shows the case of using three or more correlation coefficients.

FIG. 23(a) illustrates measurement of a deflection amount and a surface displacement amount of a bridge in a second application example of the example embodiments of the invention, and FIG. 23(b) shows a deflection cure of the bridge shown in FIG. 23(a).

FIG. 24 is a block diagram showing an example of a computer that realizes the degradation state determination apparatus according to the first to fourth example embodiments of the invention.

### EXAMPLE EMBODIMENT

### First Example Embodiment

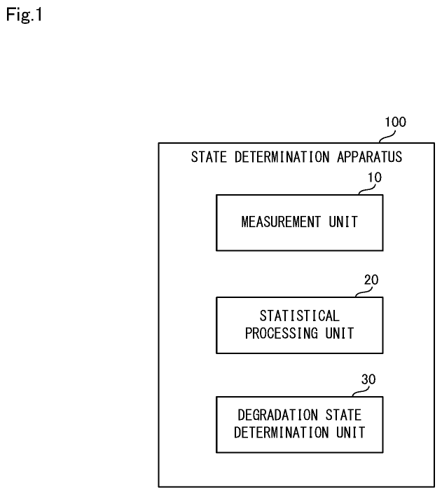

Hereinafter, a state determination apparatus, a state determination method, and a program according to the first example embodiment of the invention will be described with reference to FIGS. 1 to 10. Although the following embodiments provide limitations that are technically preferable for carrying out the invention, these limitations are not intended to limit the scope of the invention to the following embodiments.

### [Apparatus Configuration]

First, a schematic configuration of the state determination apparatus according to the first example embodiment will be described with reference to FIG. 1, FIG. 1 is a block diagram illustrating a schematic configuration of the state determination apparatus according to the first example embodiment of the invention.

A state determination apparatus 100 according to the first example embodiment shown in FIG. 1 is an apparatus for determining the state of a structure. As shown in FIG. 1, the state determination apparatus 100 includes a measurement unit 10, a statistical processing unit 20, and a degradation state determination unit 30.

The measurement unit 10 measures a deflection amount and a surface displacement amount of a structure. The statistical processing unit 20 performs statistical processing using the measured deflection, amount and surface displacement amount. The degradation state determination unit 30 determines the degradation state of the structure based on the results of statistical processing.

Thus, according to the first example embodiment, the state determination apparatus 100 performs statistical processing using both a deflection amount and a surface displacement amount (surface distortion) of a structure, and can thus specify the relationship therebetween. Therefore, according to the first example embodiment, the degradation state of a structure can be properly determined.

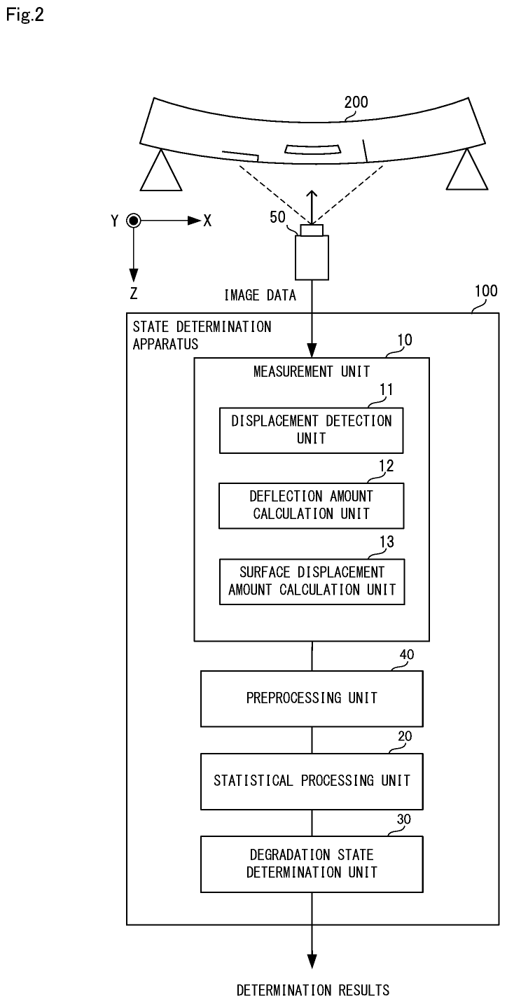

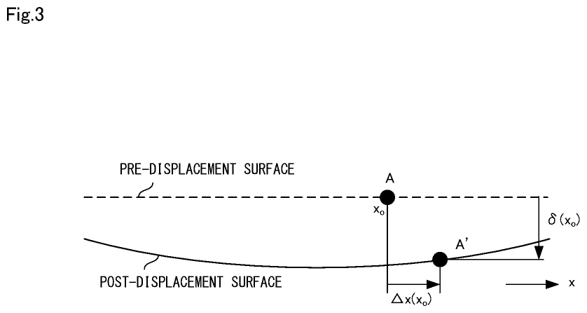

Next, a configuration of the state determination apparatus 100 according to the first example embodiment will be described in more detail with reference to FIGS. 2 to 9. FIG. 2 is a block diagram illustrating a configuration of the state determination apparatus according to the first example embodiment of the invention in detail. FIG. 3 illustrates a deflection amount and a surface displacement amount of a structure that are to be determined in the first example embodiment of the invention.

As shown in FIG. 2, in the first example embodiment, a target structure 200 is a bridge. In FIG. 2, the structure 200 is simplified. Also, in the first example embodiment, the state determination apparatus 100 is connected to an image capture device 50, as shown in FIG. 2.

In the first example embodiment, the image capture device 50 is arranged such that a lower surface region (slab) of the bridge is an image-capture target region, and outputs image data of a time-series image of the image-capture target region. The output image data is input to the measurement unit 10. Specifically, assuming that the longitudinal direction of the structure 200 is an x direction, the width direction of the structure 200 is a y direction, and the vertical direction is a z direction, the image capture device 50 is arranged such that the horizontal direction of the time-series image coincides with the x direction, the vertical direction of the time-series image coincides with the y direction, and the normal of the imaging plane coincides with the vertical direction.

In the first example embodiment, the measurement unit 10 includes a displacement detection unit 11, a deflection amount calculation unit 12, and a surface displacement amount calculation unit 13. With this configuration, the measurement unit 10 measures a deflection amount δ and a surface displacement amount Δx of the structure 200 shown in FIG. 3 based on the image data output from the image capture device 50.

The displacement detection unit 11 uses an image obtained at a certain time as a reference image, and uses other images as processing images. The displacement detection unit 11 obtains a difference between each of the process images and the reference image, and detects a displacement in the x direction and the z direction based on the obtained difference. The deflection amount calculation unit 12 calculates a deflection amount δ in the z direction of the structure 200 based on the detected displacement. The surface displacement amount calculation unit 13 removes a displacement deriving from a deflection of the structure from the detected displacement, and calculates the surface displacement amount Δx in the x direction of the structure 200.

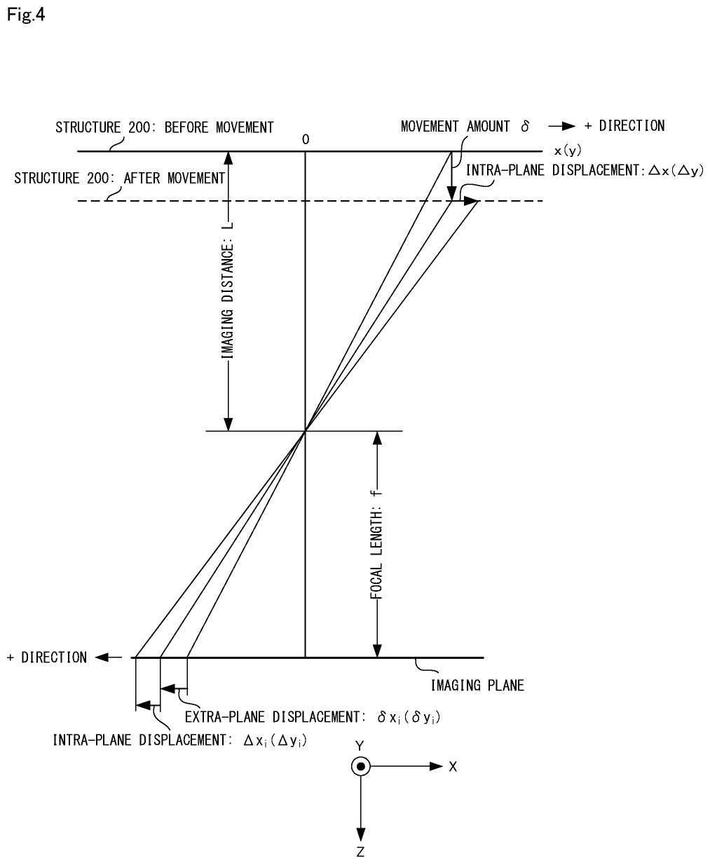

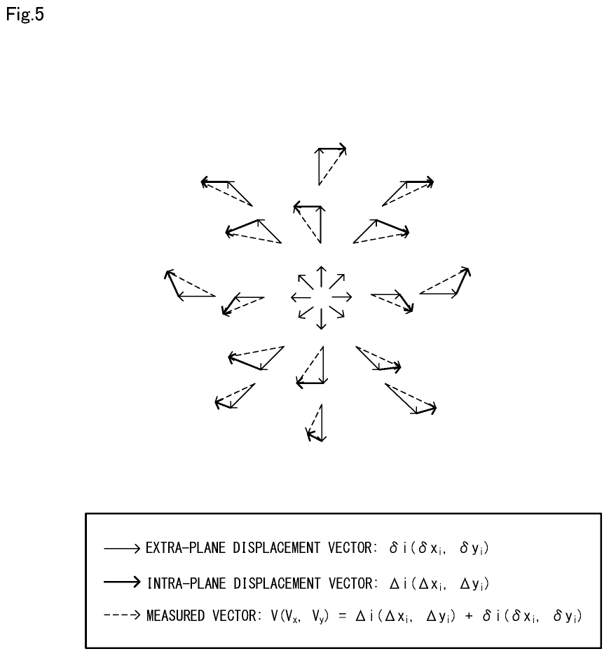

Processing performed by the measurement unit 10 will now be described in detail with reference to FIGS. 4 and 5, FIG. 4 shows a displacement of a figure in a time-series image that occurs due to a deflection of a structure.

First, if a portion of the structure 200 (e.g. a portion of the bridge to which a load is applied) moves in the vertical direction, the image-capture target region also moves in the vertical direction, and thus, a figure in the time-series image expands or contracts in accordance with the movement. Accordingly, if the deflection amount of the structure is denoted as δ, a displacement δxᵢ based on the deflection amount δ occurs on the imaging plane of the image capture device 50, separately from a displacement Δxᵢ that occurs due to the movement of the structure 200 in the x direction, as shown in FIG. 4. Similarly, a displacement δyᵢ based on the deflection amount δ occurs on the imaging plane of the image capture device 50, separately from a displacement Δyᵢ that occurs due to the movement of the structure 200 in the y direction. Also, here, the movement amount of the structure 200 in the x direction is denoted as Δx, and the movement amount of the structure 200 in the y direction is denoted as Δy.

Here, the displacements δxᵢ and δyᵢ based on the deflection amount δ are referred to as “extra-plane displacements”, and the displacements Δxᵢ and Δyᵢ based on the movement of the structure 200 in the x direction and the y direction are referred to as “intra-plane displacements”. If the imaging distance between the image-capture target region and the image capture device 50 is denoted as L, the focal length of the lens of the image capture device 50 is denoted as f, and the coordinates from the center of the image-capture target region is denoted as (x, y), the extra-plane displacement δxᵢ, the extra-plane displacement δyᵢ, the intra-plane displacement Δxᵢ, and the intra-plane displacement Δyᵢ are expressed by the following Expressions 1, 2, 3, and 4.

$$\begin{matrix}δ {x}_{i} = f ( \frac{1}{L - δ} - \frac{1}{L} ) x & [ Expression 1 ] \\ δ {y}_{i} = f ( \frac{1}{L - δ} - \frac{1}{L} ) y & [ Expression 2 ] \\ Δ {x}_{i} = \frac{f}{L - δ} Δ x & [ Expression 3 ] \\ Δ {y}_{i} = \frac{f}{L - δ} Δ y & [ Expression 4 ]\end{matrix}$$

Also, if the above Expressions 1 and 2 are collectively referred to as an extra-plane displacement vector δi(δxᵢ, δyᵢ), this extra-plane displacement vector δi(δxᵢ, δyᵢ) is expressed by the following Expression 5. If the above Expressions 3 and 4 are collectively referred to as an intra-plane displacement vector Δi(Δxᵢ, Δyᵢ), this intra-plane displacement vector Δi(Δxᵢ, Δyᵢ) expressed by the following Expression 6.

$$\begin{matrix}δ i ( δ {x}_{i} , δ {y}_{i} ) = ( f ( \frac{1}{L - δ} - \frac{1}{L} ) x , f ( \frac{1}{L - δ} - \frac{1}{L} ) y ) & [ Expression 5 ] \\ Δ i ( Δ {x}_{i} , Δ {y}_{i} ) = ( \frac{f}{L - δ} Δ x , \frac{f}{L - δ} Δ y ) & [ Expression 6 ]\end{matrix}$$

FIG. 5 shows an example of displacement vectors in a time-series image of the reference plane. Specifically, FIG. 5 Shows a relationship between the extra-plane displacement vector δi(δxᵢ, δyᵢ) and the intra plane displacement vector Δi(Δxᵢ, Δyᵢ) that are expressed by the above Expressions 5 and 6. As shown in FIG. 5, the extra-plane displacement vector δi(δxᵢ, δyᵢ) is a radial vector grasp (thin solid line arrows in FIG. 5), and the magnitude R(x, y) thereof is expressed by the following Expression 7, based on the above Expressions 1 and 2. As indicated by the following Expression 7, if the deflection amount δ is constant, the magnitude thereof takes a value that is in proportion to the distance from the imaging center. Also, if the proportionality constant is denoted as k as shown in the following Expression 8, the following Expression 7 can also be expressed by Expression 9.

$$\begin{matrix}R ( x , y ) = \sqrt{δ {{x}_{i} ( x , y )}^{2} + δ {{y}_{i} ( x , y )}^{2}} = f ( \frac{1}{L - δ} - \frac{1}{L} ) \sqrt{{x}^{2} + {y}^{2}} & [ Expression 7 ] \\ k = f ( \frac{1}{L - δ} - \frac{1}{L} ) & [ Expression 8 ] \\ R ( x , y ) = k \sqrt{{x}^{2} + {y}^{2}} & [ Expression 9 ]\end{matrix}$$

The displacement distribution is indicated by synthetic vectors (dotted line arrows in FIG. 5) of extra-plane displacement vectors δi(δxᵢ, δyᵢ) (thin solid line arrows in FIG. 5) and intra-plane displacement vectors Δi(Δxᵢ, Δyᵢ) (thick solid line arrows in FIG. 5). If each of these synthetic vectors is regarded as a measured vector V(Vx, Vy) and the magnitude thereof is denoted as Rmes(x, y), the measured vector V(Vx, Vy) and the magnitude Rmes(x, y) thereof can be expressed by the following Expressions 10 and 11. In the first example embodiment, the displacement detection unit 11 calculates, as a displacement, Rmes(x, y) expressed by the following Expression 10 and the measured vector V(Vₓ, V_{y}) expressed by the following Expression 11.

Rmes (x, y)=\sqrt{Vx(x, y)²+Vy(x, y)²} [Expression 10]

V(Vₓ, V_{y})=Δ/(Δxᵢ, Δyᵢ)+δi(δxᵢ, δyᵢ) [Expression 11]

The larger the deflection amount δ, the larger the magnitude R(x, y) of the extra-plane displacement vector δi(δxᵢ, δyᵢ). The enlargement ratio of R(x, y) corresponds to a proportionality constant k given by the above Expression 8. Also, if the magnitude R(x, y) of the extra-plane displacement vector is greater than that of the intra-plane displacement vector Δi(Δxᵢ, Δyᵢ), the magnitude Rmes(x, y) of the measured vector V(Vx, Vy) varies similarly to the magnitude R(x, y) of the extra-plane displacement vector. For this reason, the expansion ratio of R(x, y) can be estimated based on Rmes(x, y). Specifically, the expansion ratio of R(x, y) can be estimated by obtaining the proportionality constant k that minimalizes an evaluation function E(k) expressed by the following Expression 12.

$$E ( k ) = {\sum }_{x , y} {\{ {R}_{max} ( x , y ) - R ( x , y , k ) \}}^{2} \qquad [ Expression 12 ]$$

Accordingly in the first example embodiment, the deflection amount calculation unit 12 applies the least squares method to the above Expression 12 and calculates an expansion coefficient k. Note that, in place of the sum of squares of differences between Rmes(x, y) and R(x, y) indicated by the above Expression 12, the sum of absolute values, the sum of other powers, or the like may alternatively be used as the evaluation function E(k). Furthermore, provided that the expansion ratios in an imaging region before and after movement can be obtained, the deflection amount calculation unit 12 may use any kind of algorithm.

The deflection amount calculation unit 12 then applies the calculated expansion coefficient k to the above Expression 8 and calculates the deflection amount δ. Also, the surface displacement amount calculation unit 13 substitutes the deflection amount δ into the above Expression 5 and calculates the extra-plane displacement vector δi(δxᵢ, δyᵢ). Furthermore, the surface displacement amount calculation unit 13 calculates the intra-plane displacement vector. Δi(Δxᵢ, Δyᵢ) by subtracting the calculated extra-plane displacement vector δi(δxᵢ, Δyᵢ) from the measured vector V(Vx, Vy) calculated by the displacement detection unit 11 (see the above Expression 11).

Thereafter, the surface displacement amount calculation unit 13 further applies the calculated intra-plane displacement vector Δi(Δxᵢ, Δyᵢ) and the deflection amount δ to the above Expression 6, and calculates the surface displacement amounts Δx and Δy of the structure. Note that, in. the first example embodiment, the surface displacement amount calculation unit 13 may only calculate the surface displacement amount Δx in the x direction.

Although the deflection amount is also calculated based on the time-series image in the above example, in the first example embodiment, a distance-measuring device for measuring the distance between the structure 200 and the image capture device 50 may also be provided in addition to the image capture device 50. In this case, the measurement unit 10 measures the deflection amount based on data obtained from the distance-measuring device. Examples of distance-measuring devices may include a laser distance meter, a contact accelerometer, and a distance meter that uses a distortion sensor. The laser distance meters may be a laser interferometer, a laser distance meter that uses a light-section method, a time-of-flight laser displacement meter, or a laser Doppler velocimeter.

The deflection amount δ varies depending on the portion of the structure 200 or the 2. Position to which a load is applied. Accordingly, the deflection amount δ can be denoted as a deflection amount δ(x) at x. Also, the surface displacement amount at x can be denoted as Δx(x).

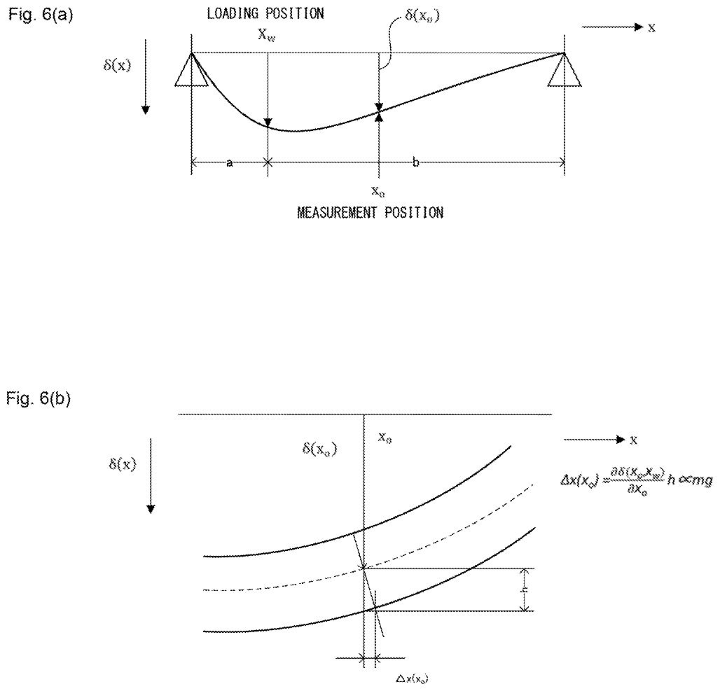

The deflection amount δ(x) will now be described as a premise for determining the degradation state of the structure 200, with reference to FIG. 6. FIG. 6 illustrates a deflection amount δ(x) calculated in the first, example embodiment of the invention. FIG. 6(a) shows a beam that corresponds to a structure, and FIG. 6(b) shows an enlarged portion of the beam.

It is assumed that a concentrated load is applied to a single point that internally divides a double-supported beam at a ratio of a:b, as shown in FIG. 6(a). In this case, the deflection amount δ(x) is given by the following Expressions 13 and 14. Here, L denotes the span length of the beam, m denotes the load, E denotes the Young's modulus, I denotes the geometrical moment of inertia of the beam, and g denotes the gravitational acceleration. Furthermore, if the load position and the measurement position are denoted as x_{w} and xₒ, respectively, the following Expressions 13 and 14 are rearranged as expressed by Expressions 15 and 16.

$$\begin{matrix} δ ( x ) = \frac{mg}{6 EIL} \{ bx ( - {x}^{2} + a ( a + 2 b ) \} ( 0 < x < a ) & [ Expression 13 ] \\ δ ( x ) = \frac{mg}{6 EIL} \{ a ( L - x ) ( - {( L - x )}^{2} + b ( b + 2 a ) \} ( a < x < L ) & [ Expression 14 ] \\ δ ( {x}_{o} ) = \frac{mg}{6 EIL} ( L - {x}_{w} ) {x}_{o} [ - {x}_{o}^{2} + {x}_{w} \{ {x}_{w} + 2 ( L - {x}_{w} ) \} ] ( 0 < {x}_{o} < {x}_{w} ) & [ Expression 15 ] \\ δ ( {x}_{o} ) = \frac{mg}{6 EIL} ( L - {x}_{o} ) {x}_{w} [ - {x}_{w}^{2} + {x}_{o} \{ {x}_{o} + 2 ( L - {x}_{o} ) \} ] ( {x}_{w} < {x}_{o} < L ) & [ Expression 16 ]\end{matrix}$$

Also, as is understood from the relationship shown in FIG. 6(b), the surface displacement Δx(xₒ) at the measurement position xₒ is expressed by the following Expression 17, and is proportional to the load mg, similarly to Expressions 15 and 16. Note that, here, h denotes the distance from the neutral line to the lower surface of the beam.

$$Δ x ( {x}_{o} ) = \frac{\partial δ ( {x}_{o} , {x}_{w} )}{\partial {x}_{o}} h ∝ mg \qquad [ Expression 17 ]$$

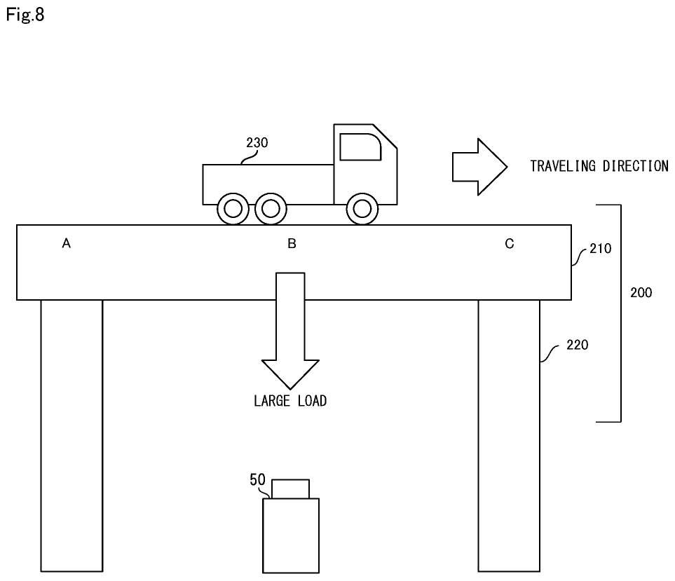

As shown in FIG. 2, in the first example embodiment, the state determination apparatus 100 includes a preprocessing unit 40, in addition to the measurement unit 10, the statistical processing unit 20, and the degradation state determination unit 30. The preprocessing unit 40 performs, as preprocessing, processing to record the deflection amount δ and the surface, displacement amount Δx measured by the measurement unit 10 in association with a measurement condition, before the statistical processing performed by the statistical processing unit 20. Specifically, in the later-described example shown in FIG. 8, the preprocessing unit 40 records the deflection amount δ and the surface displacement amount Δx, for each vehicle that passes over the bridge, which is the structure 200.

Also, in the first example embodiment, the statistical processing unit 20 obtains the relationship between the deflection amount δ(xₒ) and the surface displacement amount Δx(xₒ), based on the deflection amount ô(xₒ) and the surface displacement amount Δx(xₒ) relative to each load that are recorded by the preprocessing unit 40. The degradation state determination unit 30 then determines the degradation state of the structure 200 based on the relationship obtained by the statistical processing unit 20.

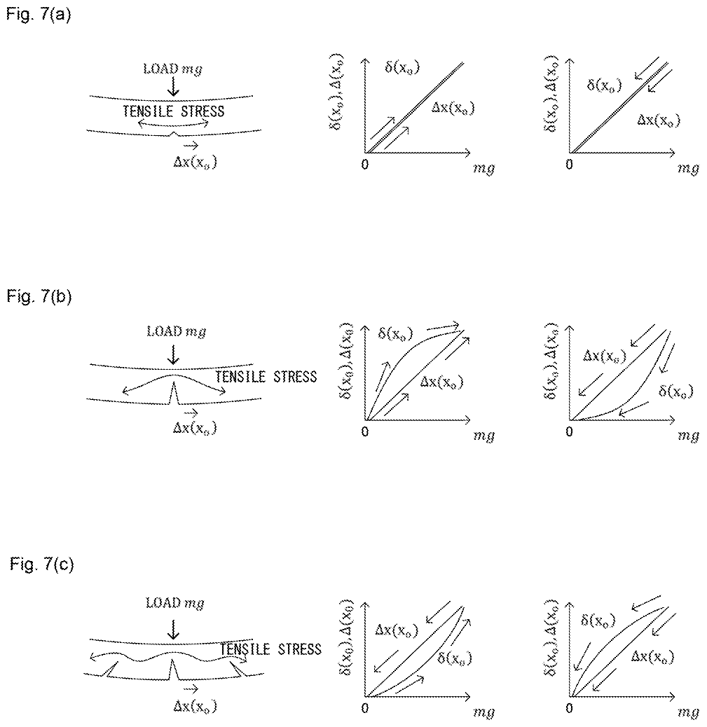

Next, the statistical processing performed by the statistical process unit 20 will be described in detail with reference to FIG. 7. FIGS. 7(a) to 7(c) show the relationship between deflection amount and a surface displacement amount, of a structure, and show cases where the state of the structure differs. In FIGS. 7(a) to (c), the left diagrams show a schematic configuration of the structure that is in a degraded state, the center diagrams slow a change in the deflection amount and the surface displacement amount in the case where load is increasing, and the right diagrams show a change in the deflection amount and the surface displacement amount in the case where the load is decreasing.

As shown in the left diagram in FIG. 7(a), if a shallow crack is formed in the structure, both the deflection amount δ(xₒ) and the surface displacement Δx(xₒ) change proportionally to the load mg at the measurement position xₒ near the surface where tensile stress occurs, similarly to the case expressed by the above Expression 17. Accordingly, the deflection amount δ(xₒ) and the surface displacement amount Δx(xₒ) change with the same tendency accordance with the increase and decrease in the load mg, as shown in the center and right diagrams in FIG. 7(a).

If a crack that has occurred in the structure becomes deeper as shown in the left diagram in FIG. 7(b), the tensile stress component (tensile field) significantly curves in a region around the crack near the surface, and the tensile stress near the surface decreases. For this reason, as shown in the center and right diagrams in FIG. 7(b), the surface displacement amount Δx(xₒ) tends to change less than deflection amount δ(xₒ) when the same load mg is applied, compared with the case shown in FIG. 7(a). Furthermore, as a result, the relationship between the deflection amount δ(xₒ) and the surface displacement amount Δx(xₒ) differs between when the load mg at the measurement position xₒ tends to increase (center diagram in FIG. 7(b)) and when the load tug tends to decrease (right diagram in FIG. 7(b)).

Furthermore, if a plurality of cracks are formed in structure as shown in the left diagram in FIG. 7(c), the curvature of the tensile field due to the tensile stress decreases. Also, the surface of the structure can readily move due to fractures on the surface caused by the plurality of cracks. For this reason, as shown in the center and right diagrams in FIG. 7(c), the relationship between the deflection amount δ(xₒ) and the surface displacement amount Δx(xₒ) is closer to the proportional relationship shown in FIG. 7(a), but the surface displacement amount Δx(xₒ) tends to change slightly greater than the deflection amount δ(xₒ) when the same load mg is applied, compared with the case shown in FIG. 7(a). Also, in FIG. 7(c) as well, the relationship between the deflection amount δ(xₒ) and the surface displacement amount Δx(xₒ) differs between When the load mg at the measurement position xₒ tends to increase (center diagram) and when the load mg tends to decrease (right diagram).

Thus, based on mechanical principles, the relationship between the deflection amount δ(xₒ) and the surface displacement amount Δx(xₒ) of the structure 200 differs in accordance with the degradation, state of the structure 200, under the condition that the same load is applied. Accordingly, the state of the structure 200 can be determined if this relationship can be understood. For this reason, the statistical processing unit 20 obtains the relationship between the deflection amount δ(xₒ) and the surface displacement amount Δx(xₒ) based on the deflection amount δ(xₒ) and the surface displacement amount Δx(xₒ) relative to each measurement condition (passing vehicle) that are recorded by the preprocessing unit 40, as mentioned above.

Specifically, the statistical processing unit 20 calculates a correlation coefficient of the deflection amount δ(xₒ) and the surface displacement amount Δx(xₒ) as the relationship therebetween, based on the deflection amount δ(xₒ) and the surface displacement amount Δx(xₒ) relative to each measurement condition (passing vehicle). Although the calculation formula of the correlation coefficient is not specifically limited, in the first example embodiment, the calculation formula expressed by the following Expression 18 can be used, for example. In the following Expression 18, δⱼ(xₒ) expresses the deflection amount relative to each passing vehicle, and Δxⱼ(xₒ) expresses the surface displacement amount relative to each passing vehicle.

$$r = \frac{{\sum }_{j = 1}^{n} ( {δ}_{j} ( {x}_{o} ) - \overline{δ ( {x}_{o} )} ) ( Δ {x}_{j} ( {x}_{o} ) - \overline{Δ x ( {x}_{o} )} )}{{( ( {\sum }_{i = 1}^{n} {( {δ}_{j} ( {x}_{o} ) - \overline{δ ( {x}_{o} )} )}^{2} ) ( {\sum }_{i = 1}^{n} {( Δ {x}_{j} ( {x}_{o} ) - \overline{Δ x ( {x}_{o} )} )}^{2} ) )}^{1 \text{/} 2}} \qquad [ Expres s i on 18 ]$$

The degradation state determination unit 30 determines the degradation state of the structure 200 by checking the correlation coefficient calculated by the statistical processing unit 20 against a pre-created look-up table. The relationship between values of the correlation coefficient and the degradation state of the structure 200 is registered in the look-up table.

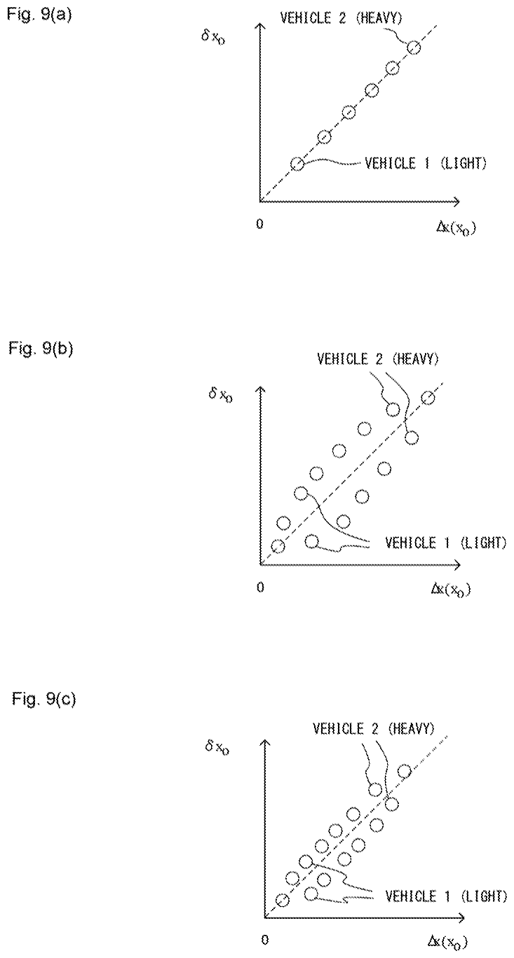

Next, determination of the degradation state performed by the degradation state determination unit 30 will be described in detail with reference to FIGS. 8 and 9. FIG. 8 illustrates a load applied to a bridge in the case where the structure is a bridge. FIGS. 9(a) to 9(c) show examples of the relationship between the deflection amount and the surface displacement amount of the structure in the example in FIG. 8, and show cases where the state of the structure differs.

As shown in FIG. 8, a bridge (which will be also referred to as a “bridge 200”), which is the structure 200, includes a slab 210 and a bridge girder 220. The image capture device 50 is arranged at the measurement position xₒ such that the lower surface of the slab 210 of the bridge 200 is an image-capture target region. If a vehicle 230 passes over the bridge 200, a load is applied to the bridge 200. The image capture device 50 outputs image data of a time-series image of the image-capture target region when the vehicle 230 passes over the bridge 200.

The measurement unit 10 measures the deflection amount δ(xₒ) and the surface displacement amount Δx(xₒ) every time the vehicle 230 passes over the bridge 200, based on the output image data. The measurement results are as shown in FIGS. 9(a) to 9(c), depending on the degradation state of the structure 200. FIGS. 9(a) to 9(c) are obtained by plotting points specified by the deflection amount δ(xₒ) and the surface displacement amount Δx(xₒ) for each of a plurality of vehicles 230 in the case where a plurality of vehicles with different weights pass over the bridge 200.

In the example in FIG. 9(a), the bridge 200 is in a state where the slab 210 is sound, or a state where a shallow crack has occurred in the slab 210 (see FIG. 7(a)). In the state shown in FIG. 9(a), as shown in the center and right diagrams in FIG. 7(a), both the deflection amount δ(xₒ) and the surface displacement amount Δx(xₒ) that occur in accordance with the load applied due to the vehicle 230 passing vary proportionally to the load, as expressed by the following Expression 17. Accordingly, as shown in FIG. 9(a), points corresponding to the respective vehicles are plotted on a line. Specifically, points corresponding to a vehicle 1 (weight:light) and points corresponding to a vehicle 2 (weight:heavy) are plotted on the same line.

In the example in FIG. 9(b), the bridge 200 is in a state where a deep crack has occurred in the slab 210 (see FIG. 7(b)). In the state shown in 9(b), as shown in the center and right diagrams in FIG. 7(b), the surface displacement amount Δx(xₒ) varies less than the deflection amount δ(xₒ), and the relationships therebetween differs between when the load at the measurement position xₒ tends to increase and when it tends to decrease. Accordingly, as shown in FIG. 9(b), two points are specified by the deflection amount δ(xₒ) and the surface displacement amount Δx(xₒ) relative to each vehicle, and are plotted at positions deviated from a line.

In the example in FIG. 9(c), the bridge 200 is in a state where a plurality of cracks have occurred in the slab 210 (see FIG. 7(c)). In the state shown in FIG. 9(c), as shown in the center and right diagrams in FIG. 7(c), the relationship between the deflection amount δ(xₒ) and the surface displacement amount Δx(xₒ) is close to a proportional relationship, but the surface displacement amount Δx(xₒ) varies slightly greater than the deflection amount δ(xₒ). In this case as well, the relationship therebetween differs between when the load at the measurement position xₒ, tends to increase and when it tends to decrease. Accordingly, as shown in FIG. 9(c), two points are specified by the deflection amount δ(xₒ) and the surface displacement amount Δx(xₒ) relative to each vehicle, and are plotted at positions that are slightly deviated from a line.

Also, as a result of applying the deflection amounts δ(xₒ) and the surface displacements Δ(xₒ) shown in FIGS. 9(a), 9(b), and 9(c) to the above Expression 18 and calculating correlation coefficients, the respective correlation coefficients were 0.98, 0.90, and 0.80. This indicates that the degradation state of the bridge 200 can be determined using the correlation coefficient of the deflection amount δ(xₒ) and the surface displacement Δx(xₒ). Accordingly, in the first example embodiment, the aforementioned look-up table is created while associating the correlation coefficient with the state of the bridge, and the degradation state determination unit 30 determines the degradation state using this look-up table.

### [Apparatus Operation]

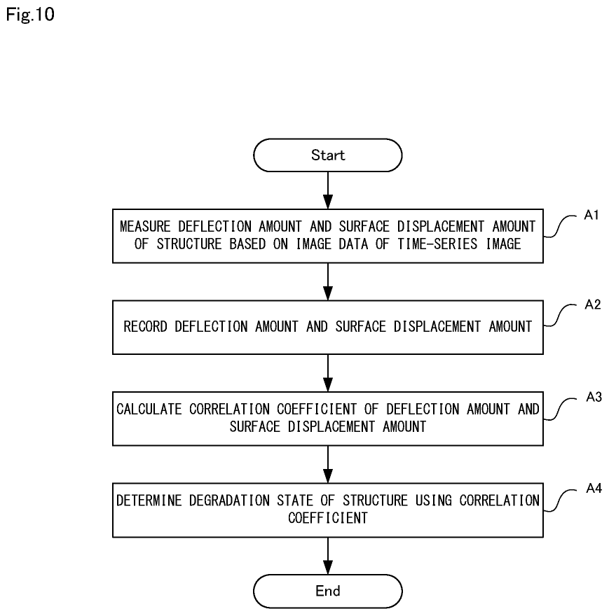

Next, operations of the state determination apparatus 100 according to the first example embodiment of the invention will be described with reference to FIG. 10. FIG. 10 is a flowchart showing operations of the state determination apparatus according to the first example embodiment of the invention. The following description will reference FIGS. 1 to 9 as appropriate. Also, in the first example embodiment, a state determination method is carried out by operating the state determination apparatus 100. Accordingly, the following description of the operations of the state determination apparatus 100 replaces the description of the state determination method according to the first example embodiment.

As shown in FIG. 10, first, the measurement unit 10 acquires image data from the image capture device 50, and measures the deflection amount δ(xₒ) and the surface displacement amount Δx(xₒ) of the structure 200 based on the acquired image data (step A1).

Next, the preprocessing unit 40 records the deflection amount δ(xₒ) and the surface displacement amount Δx(xₒ) measured in step A1 in association with the vehicle 230 that passes over the structure 200 during the measurement (step A2). Steps A1 and A2 are repeatedly performed until a sufficient volume of data is recorded.

Next, the statistical processing unit 20 calculates a correlation coefficient of the deflection amount δ(xₒ) and the surface displacement amount Δx(xₒ) using the data recorded in step A2 (step A3). Specifically, the statistical, processing unit 20 first, specifies the largest value of the deflection amount ô(xₒ) and the surface displacement amount Δx(xₒ) at this time, for each vehicle. The statistical processing unit 10 then calculates the correlation coefficient using the above Expression 18, with the specified deflection amount δ(xₒ) and surface displacement amount Δx(xₒ) relative to each vehicle denoted as δⱼ(xₒ) and Δxⱼ(xₒ).

Next, the degradation state determination unit 30 determines the degradation state of the structure 200 by checking the correlation coefficient calculated in step A3 against the pre-created look-up table (step A4). Then, the degradation state determination unit 30 outputs the determination result to an external service.

### [Effects of First Example Embodiment]

As described above, according to the first example embodiment, a correlation coefficient of the deflection amount δ(xₒ) and the surface displacement amount Δx(xₒ) of the structure 200 is obtained, and the degradation state of the structure 200 is determined based on the correlation coefficient. Since the value of the correlation coefficient differs depending on the degradation state of the structure 200 according to the first example embodiment, the degradation state of the structure 200 can be properly determined.

Although, in the above example, the statistical processing unit 20 performs statistical processing to calculate a correlation coefficient of the deflect amount δ(xₒ) and the surface displacement amount Δx(xₒ), the statistical processing is not limited to processing to calculate the correlation coefficient. The statistical processing need only be processing that makes it possible to specify the relationship between the deflection a δ(xₒ) and the surface displacement amount Δx(xₒ).

Furthermore, although the above example, the degradation state determination unit 30 determines the degradation state using a look-up table, processing to determine the degradation state according to the first example embodiment is not limited thereto. For example, in the first example embodiment, the degradation state determination unit 30 can also learn the correspondence relationship between an index, such a correlation coefficient, and the degradation state through machine learning to generate a learning model, and determine the degradation state using the generated learning model.

### [Program]

A program according to the first example embodiment need only be a program for causing a computer to perform steps A1 to A4 shown in FIG. 10. The state determination apparatus 100 and the state determination method according to the first example embodiment can be realized by installing this program on a computer and executing the program. In this case, a CPU (Central Processing Unit) of the computer functions as the measurement unit 10, the statistical processing unit 20, the degradation state determination unit 30, and the preprocessing unit 40, and performs processing.

The program according to the first example embodiment may also be executed by a computer system that includes a plurality of computers. In this case, for example, each of the computers may function as any of the measurement unit 10, the statistical processing unit 20, the degradation state determination unit 30, and the preprocessing unit 40.

### Second Example Embodiment

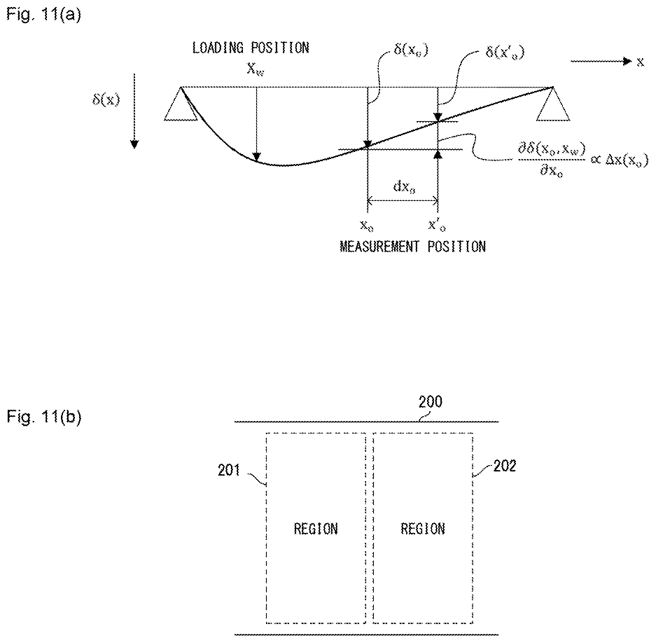

Next, a state determination apparatus, a state determination method, and a program according to the second example embodiment of the invention will be described with reference to FIGS. 11 to 15.

### [Apparatus Configuration]

First, a configuration of the state determination apparatus according to the second example embodiment will be described. The state determination apparatus according to the second example embodiment is configured similarly to the state determination apparatus 100 according to the first example embodiment shown in FIG. 2. However, the state determination apparatus according to the second example embodiment differs from the state determination apparatus 100 according to the first example embodiment in terms of processing performed by the statistical processing unit 20 and the preprocessing unit 40. The following description will focus on the differences from the first example embodiment. In the following description, the structure 200 that is to undergo determination is a bridge. FIGS. 1 and 2 will be referenced as appropriate.

In the second example embodiment, the measurement unit 10 calculates a difference Δδ(xₒ, t) in the deflection amount when a vehicle passes. The preprocessing unit 40 records, for each vehicle that passes over the bridge 200, the calculated difference Δδ(xₒ, t) in the deflection amount and the surface displacement amount Δx(xₒ, t) at the same time.

In the second example embodiment, the statistical processing unit 20 calculates a correlation coefficient of die difference Δδ(xₒ, t) in the deflection amount and the surface displacement amount Δx(xₒ, t) at the same time. The degradation state determination unit 30 determines the degradation state of the structure 200 by checking the correlation coefficient calculated by the statistical processing unit 20 against a pre-created look-up table.

To describe the determination of the degradation state of the structure (bridge) 200 according to the second example embodiment in detail, first, the difference Δδ(xₒ, t) in the deflection amount will now be described with reference to FIG, 11. FIG. 11(a) illustrates a deflection amount calculated in the second example embodiment of the invention using an example of the structure, and FIG. 11(b) shows the lower surface of the structure shown in FIG. 11(a).

It is assumed that a load is applied to a loading position x_{w} on a double-supported beam, which is the beam 200, as shown in FIG. 11(a). Also, in the second example embodiment, it is assumed that two measurement positions xₒ and xₒ′ are provided, the measurement position xₒ is present in a region 201 shown in FIG. 11(b), and the measurement position xₒ′ is present in a region 202 shown in FIG. 11(b).

In the second example embodiment, the measurement unit 10 measures the deflection amount δ(xₒ, t) at the measurement position xₒ in the region 201 shown in FIG. 11(b), and the deflection amount δ(xo′, t) at the measurement position xₒ′ in the region 202, and also measures the <surface displacement amount (movement amount) Δx(xₒ, t) at the measurement position xₒ the region 201.

Here, if the difference Δδ(xₒ, t)=δ(xₒ, t) in the deflection amount is obtained., a value is obtained that is proportional to a value obtained by differentiating the deflection amount δδ(xₒt) with respect to xₒ. For this reason, in the second example embodiment, the difference Δδ(xₒ, t) in the deflection amount and the surface displacement Δx(xₒ, t) are compared at each time t.

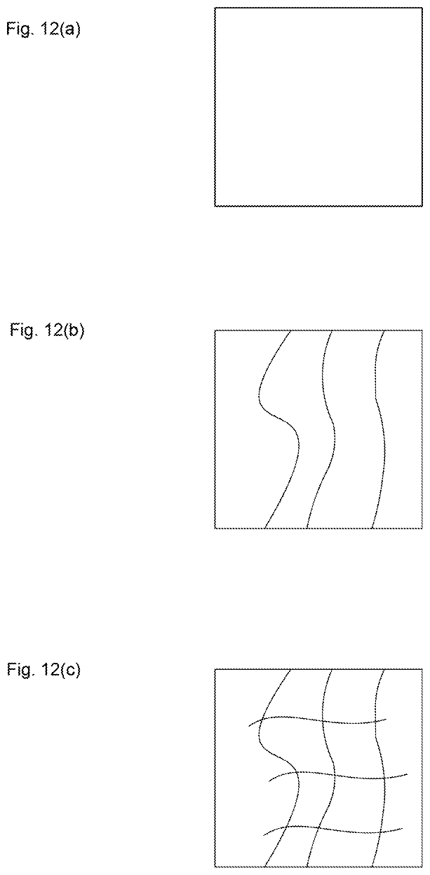

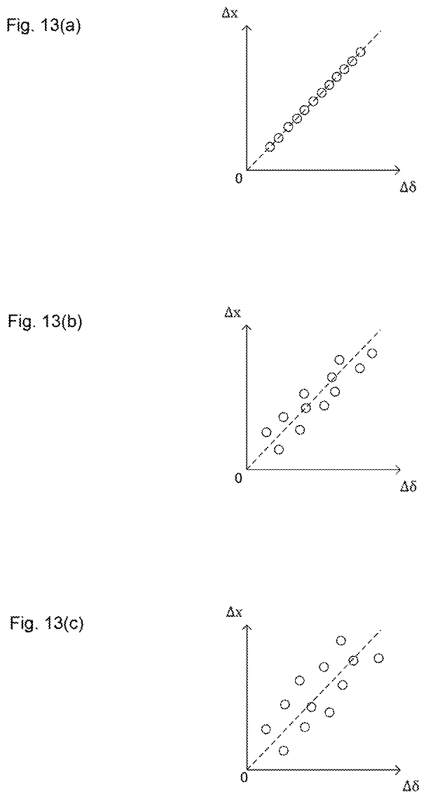

Next, a specific example of the determination of the degradation state will be described with reference to FIGS. 12 and 13. FIGS. 12(a) to 12(c) show examples of the degradation state of the lower surface of the structure, and show different states. FIGS. 13(a) to 13(c) show examples of the relationship between the difference in the deflection amount and the surface displacement amount of the structure, and show cases Where the state of the structure differs.

In the example in FIG. 12(a), the bridge 200 is in a state where the slab is sound, or a state where a shallow crack has occurred in the slab. In this case, the difference Δδ(xₒ, t) in the deflection amount and the surface displacement amount Δx(xₒ, t) are proportional to each other, based on the relationship expressed by the above Expressions 17. Accordingly, as indicated in FIG. 13(a), all of the points specified by the difference Δδ(xₒ, t) in the deflection amount and the surface displacement amount Δx(xₒ, t) are plotted on the same line, regardless of time t.

In the example in FIG. 12(b), the bridge 200 is in a state where cracks extending in one direction have occurred in the slab. In this case, since the transmission of stress that occurs in the bridge 200 is inhibited by the cracks, the relationship expressed by the above Expressions 15 and 16 does not hold. Accordingly, the points specified by the difference Δδ(xₒ, t) in the deflection amount and the surface displacement amount Δx(xₒ, t) are plotted at positions deviated from a line, as shown in FIG. 13(b).

Furthermore, in the example in FIG. 12(c), the bridge 200 is in a state where cracks extending in two directions have occurred in the slab. In this case, since the number of cracks is greater than that in the example in FIG. 12(b), the transmission of stress that occurs in the bridge 200 is further inhibited. For this reason, as shown in FIG. 13(c), the points specified by the difference Δδ(xₒ, t) in the deflection amount and the surface displacement amount Δx(xₒ, t) are plotted at positions that are further deviated from a line, and the degree of dispersion is greater than that in the example in FIG. 13(a).

As a result of applying the differences Δδ(xₒ, t) in the deflection amount and the surface displacement amounts Δx(xₒ, t) shown in FIGS. 13(a), 13(b), and 13(c) to the above Expression 18 and calculating correlation coefficients, the respective correlation coefficients were 0.98, 0.90, and 0.80. This indicates that the degradation state of the structure 200 can be determined using the correlation coefficient of the difference Δδ(xₒ, t) in the deflection amount and the surface displacement amount Δx(xₒ, t). Accordingly, in the second example embodiment as well, a look-up table is created while associating this correlation coefficient with the state of the bridge, and the degradation state determination unit 30 determines the degradation state using this look-up table.

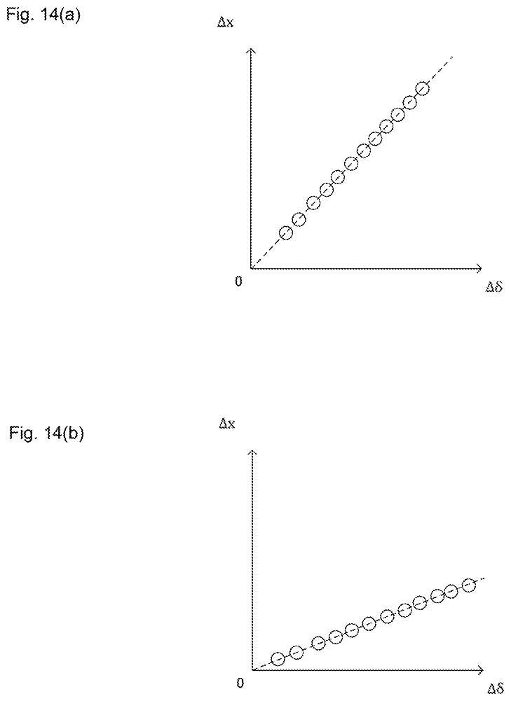

FIGS. 14(a) and 14(b) show other examples of the relationship between the difference in the deflection amount and the surface displacement amount of the structure, and show cases where the state of the structure differs.

In the example in FIG. 14(a), the bridge 200 is in a state where the slab is sound, or a state where a shallow crack has occurred in the slab, similarly to the example in FIG. 12(a), and the points specified by the difference Δδ(xₒ, t) in the deflection amount and the surface displacement Δx)xₒ, t) are plotted on the same lines, regardless of time t.

Meanwhile, in the example in FIG. 14(b) as well, all of the points specified by the difference Δδ(xₒ, t) in the deflection amount and the surface displacement Δx(xₒ, t) are plotted on the same line regardless of time t, but the tilt of the line is smaller than that in the case of FIG. 14(a). This is because, in the example in FIG. 14(a), a microcrack, which is a minute crack that is difficult to see, has occurred in the slab of the bridge 200.

For this reason, in the second example embodiment, the degradation state determination unit 30 obtains the tilt of the line if it is determined based on the correlation coefficient that the points specified by the difference Δδ(xₒ, t) in the deflection amount and the surface displacement Δx(xₒt) are on the same line. If the tilt of the line is smaller than or equal to a threshold, the degradation state determination unit 30 determines that a microcrack has occurred in the bridge 200.

### [Apparatus Operation]

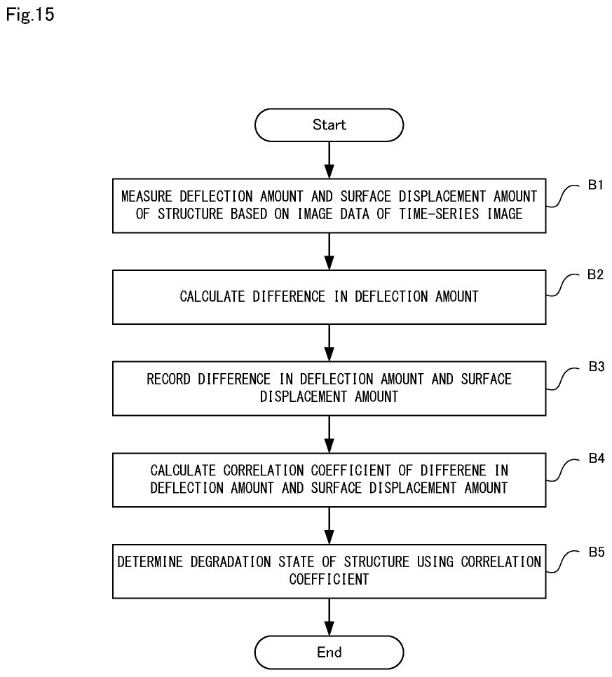

Next, operations of the state determination apparatus according to the second example embodiment of the invention will be described with reference to FIG. 15. FIG. 15 is a flowchart showing operations of the state determination apparatus according to the second example embodiment of the invention. The following description will reference FIGS. 1 to 14 as appropriate. In the second example embodiment as well, the state determination method is carried out by operating the state determination apparatus. Accordingly, the following description of the operations of the state determination apparatus replaces the description of the state determination method according to the first example embodiment.

As shown in FIG. 15, first, the measurement unit 10 acquires image data from the image capture device 50, and measures the deflection amount δ(xₒ, t) at the measurement position xₒ, the deflection amount δ(xₒ′, t) at the measurement position xₒ′, and the surface displacement amount Δx(xₒ, t) based on the acquired image data (step B1).

Next, the measurement unit 10 calculates a difference Δδ(xₒ, t) the deflection amount when a vehicle passes, using the deflection amount δ(xₒ, t) at the measurement position xₒ and the deflection amount δ(xₒ′, t) at the measurement position xₒ′ that have been measured above (step B2).

Next, the preprocessing unit 40 records the difference Δδ(xₒ, t) in the deflection amount and the surface displacement amount Δx(xₒ, t) measured in steps B1 and B2, in association with a vehicle 230 that passes over the structure 200 during measurement (step B3). Steps B1 to B3 are repeatedly performed until a sufficient volume of data is recorded.

Next, the statistical processing unit 20 calculates a correlation coefficient of the difference Δδ(xₒ, t) in the deflection amount and the surface displacement amount Δx(xₒ, t) using the data recorded in step B3 (step B4).

Next, the degradation state determination unit 30 determines the degradation state of the bridge 200 by checking the correlation coefficient calculated in step B4 against a pre-created look-up table (step B5). Then, the degradation state determination unit 30 outputs the determination result to an external device.

Also, in step B5, the degradation state determination unit 30 can determine, based on the correlation coefficient, whether or not the points specified by the difference Δδ(xₒ, t) in the deflection amount and the surface displacement amount Δx(xₒ, t) are on the same line. If, as a So result of the determination, the points are on the same line, the degradation state determination unit 30 obtains the tilt of the line, and if the tilt of the line is smaller, than or equal to the threshold, the degradation state determination unit 30 determines that a microcrack has occurred in the bridge 200.

### [Effects of Second Example Embodiment]

As described above, according to the second example embodiment, a correlation coefficient of the difference Δδ(xₒ, t) in the deflection amount and the surface displacement amount Δx(xₒ,t) of the structure 200 is obtained, and the degradation state of the structure 200 is determined based on the correlation coefficient. Since the value of the correlation coefficient differs depending on the degradation state of the structure 200, the degradation state of the structure 2 can also be properly determined according to the second example embodiment.

Furthermore, according to the second example embodiment as well, the degradation state determination unit 30 can also learn the correspondence relationship between an index, such as a correlation coefficient and the degradation state through machine learning to generate a learning model, and determine the degradation state determination unit using the generated learning model, similarly to the first example embodiment.

### [Program]

A program according to the second example embodiment need only be a program for causing a computer to perform steps B1 to B5 shown in FIG. 15. The state determination apparatus and the state determination method according to the second example embodiment can be realized by installing this program on a computer and executing the program. In this case, a CPU (Central Processing Unit) of the computer functions as the measurement unit 10, the statistical processing unit 20 the degradation state determination unit 30, and the preprocessing unit 40, and performs processing.

The program according to the second example embodiment may also be executed by a computer system that includes a plurality of computers. In this case, for example, each of the computers may function as any of the measurement unit 10, the statistical processing unit 20, the degradation state determination unit 30, and the preprocessing unit 40.

### Third Example Embodiment

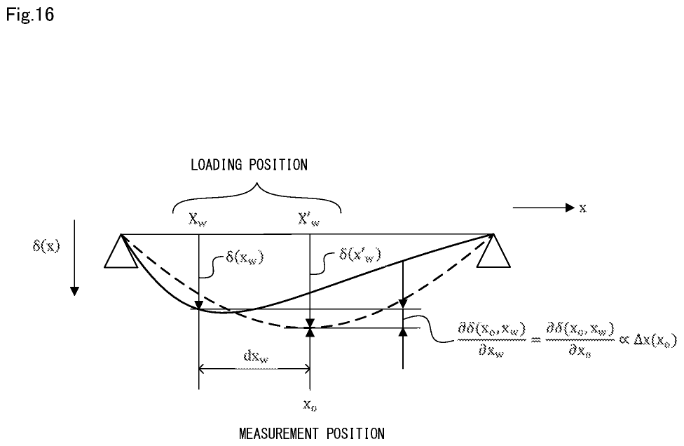

Next, a state determination apparatus, a state determination method, and a program according to the third example embodiment of the invention will be described with reference to FIGS. 16 to 19.

The state determination apparatus according to the third example embodiment is configured similarly to the state determination apparatus 100 according to the first example embodiment shown in FIG. 2. However, in the third example embodiment, the statistical processing unit 20 differs from that of the state determination apparatus 100 according, to the first example embodiment in terms of processing performed by the preprocessing unit 40. The following description will focus on the differences from the first example embodiment. In the following description, the structure 200 that is to undergo determination is a bridge. FIGS. 1 and 2 will be referenced as appropriate.

In the third example embodiment, the measurement unit 10 calculates a difference Δδ(t) in the deflection amount when a vehicle passes. The preprocessing unit 40 records, for each vehicle that passes over the bridge 200, the calculated difference Δδ(t) in the deflection amount and the surface displacement, amount Δx(xₒ, t) at the same time. Note that the difference Δδ(t) in the deflection amount calculated in the third example embodiment is not a value that is limited by the measurement position xₒ, unlike the difference Δδ(xₒ, t) in the deflection amount calculated in the second example embodiment.

In the third example embodiment, the statistical processing unit 20 calculates a correlation coefficient of the difference Δδ(t) in the deflection amount and the surface displacement amount Δx(xₒ, t) at the same time. The degradation state determination unit 30 determines the degradation state of the structure 200 by checking the correlation coefficient calculated by the statistical processing unit 20 against a pre-created look-up table.

To describe the determination of the degradation state of the structure (bridge) 200 according to the third example embodiment in detail, first, the difference Δδ(t) in the deflection amount will now be described with reference to FIG. 16. FIG. 16 illustrates a deflection amount calculated in the third example embodiment of the invention using an example of the structure.

First, the deflection amount of the bridge can be calculated using the above Expressions 15 and 16. The above Expressions 15 and 16 are symmetric with respect to a load position x_{w} and the measurement position xₒ. Accordingly, as shown in FIG. 16, a partial derivative ∂δ(xₒ, x_{w})/∂x₀ of the deflection amount δ(xₒ, x_{w}) with respect to the measurement position xₒ is equal to a partial derivative ∂δ(xₒ, x_{w})/∂x_{w} of the deflection amount δ(xₒ, x_{w}) with respect to the load position x_{w}.

Accordingly, based on the relationship indicated by FIG. 6(b) and Expression 17, the partial derivative ∂δ(xₒx_{w})∂xₒ and the partial derivative ∂δ(xₒ, x_{w})/∂x_{w} is proportional to the surface displacement Δx(x). Thus, a relationship expressed by the following Expression 19 holds therebetween.

$$\frac{\partial δ ( {x}_{o} , {x}_{w} )}{\partial {x}_{w}} = \frac{\partial δ ( {x}_{o} , {x}_{w} )}{\partial {x}_{o}} ∝ Δ x ( x ) \qquad [ Expression 19 ]$$

It is assumed here that the load position x_{w} is moving at a constant speed v due to the movement of a vehicle (see FIG. 8). In this case, the partial derivative ∂δ(xₒ, x_{w})∂x_{w} of the deflection amount δ(xₒ, x_{w}) with respect to the load position x_{w} is expressed by a time derivative ∂δ(xₒ, t)/∂t of the deflection amount δ(xₒ, t) at the measurement position xₒ, as indicated by the following Expression 20.

$$\frac{\partial δ ( {x}_{o} , t )}{\partial t} = \frac{\partial δ ( {x}_{o} , {x}_{w} )}{\partial {x}_{w}} \frac{\partial {x}_{w}}{\partial t} = \frac{\partial δ ( {x}_{o} , {x}_{w} )}{\partial {x}_{w}} v ∝ \frac{\partial δ ( {x}_{o} , {x}_{w} )}{\partial {x}_{w}} \qquad [ Expression 20 ]$$

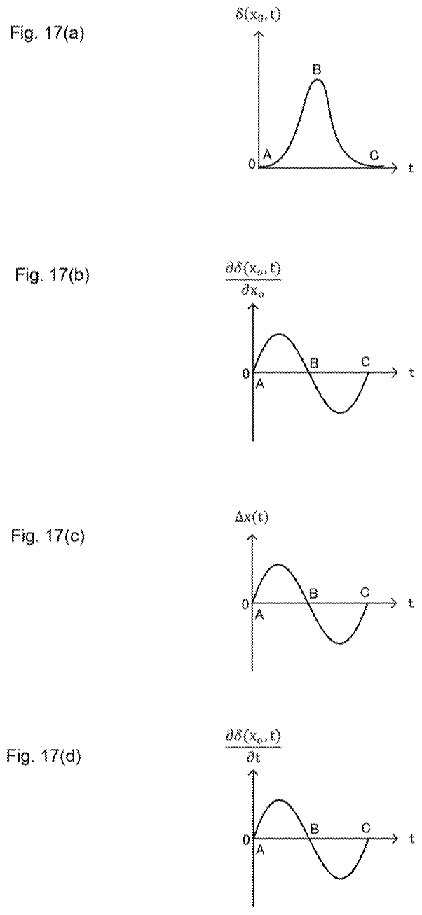

FIGS. 17(a) to 17(d) show the relationship between the deflection amount and the surface displacement amount of the bridge in the case where a vehicle, passes over the bridge, with different parameters of the vertical axes. The following description will reference FIG. 8. In FIGS. 17(a) to 17(d), times A, B, and C are times at which the vehicle 230 passes through points A, B, and C shown in FIG. 8, respectively.

FIG. 17(a) shows a temporal change in the deflection amount δ(xₒ, t) at the measurement position xₒ. As is understood from FIG. 17(a), the deflection amount δ(xₒ, t) takes the largest value at time B when the vehicle 230 passes immediately below the measurement position xₒ.

FIG. 17(b) shows a temporal change in the value obtained by differentiating the deflection amount δ(xₒ, t) with respect to xₒ. The value obtained by differentiating the deflection amount δ(xₒ, t) with respect to xₒ is proportional to the temporal change in the surface displacement Δx shown in FIG. 17(c), based on the relationship expressed in the above Expression 19.

Furthermore, FIG. 17(d) shows a temporal change in the value obtained by differentiating the deflection amount δ(xₒ, t) with respect to time t. Based on the relationship expressed by the Expression 20, the value obtained by differentiating the deflection amount δ(xₒ, t) with respect to time t is proportional to the value obtained by differentiating the deflection amount δ(xₒ, t) with respect to xₒ shown in FIG. 17(b) and the temporal change in the surface displacement Δx shown in FIG. 17(c).

Accordingly, if the difference Δδ(t)=δ(t′)−δ(t) between the deflection amount δ(t′) at time t′ and the deflection amount δ(t) at time t in the region 201 (or region 202) shown. in FIG. 11(b) is obtained, the obtained difference is proportional to the value obtained by differentiating the deflection amount δ(xₒ, t) with respect to t.

Accordingly, as expressed by the above Expression 20, if the load position is moving at the constant speed v, the difference Δδ in the deflection amount is proportional to the value obtained by differentiating the deflection amount δ(xₒ, t) with respect to xₒ, as described in the So second example embodiment. For this reason, a difference in the degradation state can be determined by comparing the difference At with the surface displacement Δx(xₒ, t).

That is to say, in a state where the slab is sound, or a state where a shallow crack has occurred in the slab, as shown in FIG. 12(a), the difference Δδ(t) in the deflection amount and the surface displacement amount Δx(xₒ, t) are proportional to each other. Accordingly, in this case as well, all of the points specified by the difference Δδ(t) in the deflection amount and the surface displacement amount Δx(xₒ, t) are plotted on the same line regardless of time t, as shown in FIG. 13(a).

In a state where cracks extending in one direction have occurred in the slab as shown in FIG. 12(b), the transmission of stress that occurs in the bridge 200 is inhibited by the cracks. Accordingly, the points specified by the difference Δδ(t) in the deflection amount and the surface displacement amount Δx(xₒ, t) are plotted at positions deviated from a line, as shown in FIG. 13(b),

Furthermore, in a state where cracks extending in two directions have occurred in the slab as shown in FIG. 12(c), the transmission of the stress that occurs in the bridge 200 is further inhibited due to an increase in the number of cracks. Accordingly, the points specified by the difference Δδ(xₒ, t) in the deflection amount and the surface displacement amount Δx(xₒ, t) are plotted at positions that are father deviated from a line, as shown in FIG. 13(c).

In the third example embodiment as well, a correlation coefficient can be calculated by applying the difference Δδ(t) in the deflection amount and the surface displacement amount Δx(xₒ, t) to the above Expression 18. In this case as well, the correlation coefficient takes a value that differs depending on the degradation state. Accordingly, it indicates that the degradation state of the bridge 200 can also be determined in the case of using the correlation coefficient of the difference Δδ(t) in the deflection amount and the surface displacement amount Δx(xₒ, t). Accordingly, in the third example embodiment as well, a look-up table is created while associating this correlation coefficient with the state of the bridge, and the degradation state determination unit 30 determines the degradation state, using this look-up table.

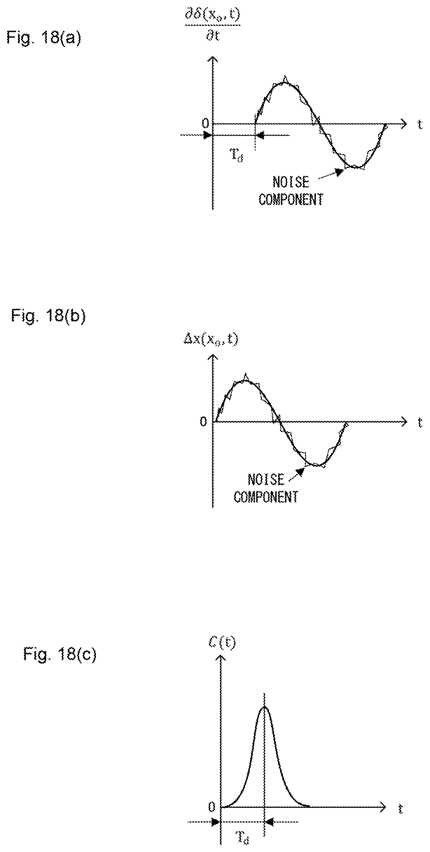

In the third example embodiment, the preprocessing unit 40 can per time compensation. This point will be described with reference to FIG. 18. FIG. 18(a) shows a temporal change in a time derivative of the deflection amount, FIG. 18(b) shows a temporal change in the surface displacement amount, and FIG. 18(c) shows a temporal change in a cross-correlation function.

When the vehicle 230 passes over the bridge 200 as shown in FIG. 8, the vehicle 230 receives a repulsive force from the road surface, and is also affected by the environment, such as wind. Accordingly, as shown in FIGS. 12(a) and 12(b), a time difference Td may occur at the measurement position xₒ between the point in time when the time derivative ∂δ(xₒ, t)∂t of the deflection amount δ(xₒ, t) rises and the point in time when the surface displacement amount Δx(xₒ, t) rises at the measurement position xₒ.

To address such a case, in the third example embodiment, the preprocessing unit 40 calculates the time difference Td, and compensates the difference Δδ(t) in the deflection amount using the calculated time difference Td. Specifically, the preprocessing unit 40 obtains a cross-correlation function C(t) of ∂δ(xₒ, t)/∂t and Δx(xₒ, t) using the following, Expression 21, and also calculates the time at which the cross-correlation function C takes the largest peak value, thereby calculating the time difference Td, as shown in FIG. 18(c).

$$C ( t ) = {\int }_{0}^{t} \frac{\partial δ ( {x}_{o} , s )}{\partial s} Δ x ( {x}_{o} , t - s ) ds \qquad [ Expression 21 ]$$

Also, since characteristic vibrations occur on the bridge 200, and the image capture device 50 itself also vibrates, noise components exist as shown in FIGS. 18(a) and 18(b). Since the noise components are at several Hz. or more, and meanwhile, the changes in the deflection amount δ and the surface displacement amount continue for one or more seconds, the preprocessing unit 40 can eliminate the noise components using a low-pass filter with a cutoff frequency of 2 Hz, for example.

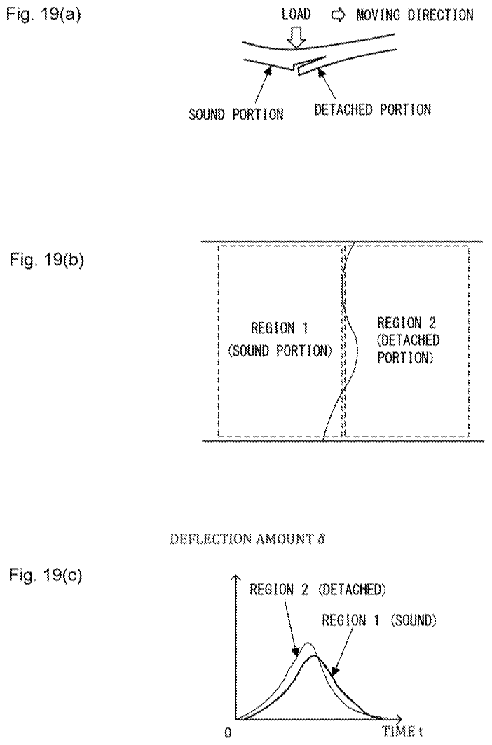

Next, the determination of the degradation state in the case where detachment has is occurred in the bridge 200 will be described with reference to FIG. 19. FIGS. 19(a) to 19(c) illustrate a state where detachment has occurred in the slab of the bridge. FIG. 19(a) shows the state of detachment in detail, FIG. 19(b) shows the lower surface of the detached slab, and FIG. 19(c) shows temporal changes in the deflection amount in a detached portion and a non-detaches portion.

As shown in FIG. 19(a), detachment refers to a state where the surface of the, slab of the bridge 200 separates therefrom. A portion where detachment has occurred and a portion where no detachment has occurred take different values of the deflection amount when the same load is applied.

However, the correlation coefficient of the difference Δδ(t) in the deflection. amount and the surface displacement amount Δx when in a detachment state is the same as that obtained when in a state where a crack has occurred, and therefore, distinction between the detachment state and the state where a crack has occurred needs to be made by comparing the deflection amounts in the two regions shown in FIG. 19(b).

Specifically, as shown in FIG. 19(c), the deflection amount in the region where detachment has occurred (region 202 in FIG. 19(b)) is greater than that in the region where no detachment has occurred (region 201 in FIG. 19(b)). In addition, the temporal change in the deflection amount in the region where detachment has occurred (region 202 in FIG. 19(b)) differs from the temporal change in the deflection amount in the region where no detachment has occurred (region 201 in FIG. 19(b)).

For this reason, in the third example embodiment, the degradation state determination unit 30 obtains the temporal changes in the deflection amount of the respective regions, and compares the obtained temporal changes in the deflection amount with each other, and can thus determine whether or not detachment has occurred in the bridge 200.

In the third example embodiment as well, the state determination apparatus operates in accordance with steps B1 to B5 shown in FIG. 15, similarly to the second example embodiment. Furthermore, the state determination method according to the third example embodiment is carried out by operating the state determination apparatus according to the third example embodiment.

### [Effects of Third Example Embodiment]

As described above, according to the third example embodiment, a correlation coefficient of the difference Δδ(t) in the deflection amount and the surface displacement amount Δx(xₒ, t) of the structure 200 is obtained, and the degradation state of the structure 200 is determined based on the correlation coefficient. Since the value of the correlation coefficient differs depending on the degradation state of the structure 200, the degradation state of the structure 200 can also be properly determined according to the third example embodiment.

Furthermore, according to the third example embodiment as well, the degradation state determination unit 30 can also learn the correspondence relationship between an index, such as a correlation coefficient, and the degradation state through machine learning to generate a learning model, and determine the degradation state determination unit using the generated learning model, similarly to the first example embodiment.

### [Program]

The program according to the third example embodiment need only be a program for causing a computer to perform steps B1 to B5 shown in FIG. 15. The state determination apparatus and the state determination method according to the third example embodiment can be realized by installing this program on a computer and executing the program. In this case, a CPU (Central Processing Unit) of the computer functions as the measurement unit 10, the statistical processing unit 20, the degradation state determination unit 30, and the preprocessing unit 40, and performs processing.

The program according to the third example embodiment may also be executed by a computer system that includes a plurality of computers. In this case, for example, each of the computers may function as any of the measurement unit 10, the statistical processing unit 20, the degradation state determination unit 30, and the preprocessing unit 40.

### Fourth Example Embodiment

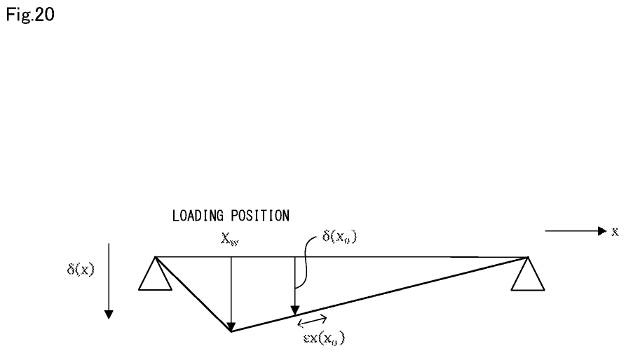

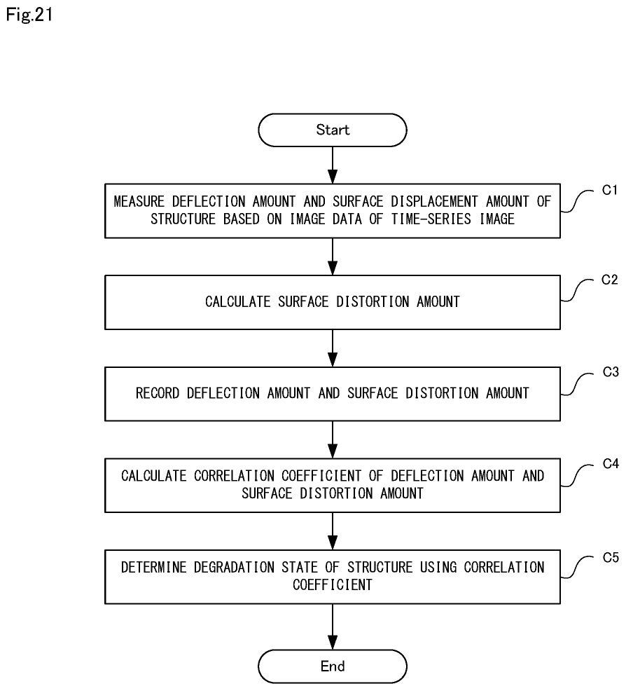

Next, a state determination apparatus, a state determination method, and a program according to the fourth example embodiment of the invention will be described with reference to FIGS. 20 and 21.

### [Apparatus Configuration]

First, a configuration of the state determination apparatus according to the fourth example embodiment will be described with reference to FIG. 20. FIGS. 20 illustrates a deflection amount calculated in the lough example embodiment of the invention using an example of a structure.

The state determination apparatus according to the fourth example embodiment is configured similarly to the state determination apparatus 100 according to the first example embodiment shown in FIG. 2. However, the state determination apparatus according to the fourth example embodiment differs from the state determination apparatus 100 according to the first example embodiment in terms of processing performed by the measurement unit 10, the statistical processing unit 20, and the preprocessing unit 40. The following description will focus on the differences from the first example embodiment. In the following description, the structure 200 that is to undergo determination is a bridge. FIGS. 1 and 2 will be referenced as appropriate.

In the fourth example embodiment, the degradation state of the bridge 200 is determined using the fact that the deflection curve shown in FIG. 11(a) can be approximated by the lines shown in FIG. 20 if the image-capture target region is sufficiently shorter than the span length of the bridge 200 (see FIG. 8).

Specifically, the deflection amount δ(xₒ) is proportional to a surface distortion amount ϵx(xₒ), as shown in FIG. 20. Accordingly, in the fourth example embodiment, the measurement unit 10 calculates the surface distortion amount ϵx(xₒ) based on the surface displacement amount Δx(xₒ, t). The preprocessing unit 40 records the calculated difference δ(xₒ, t) in the deflection amount and the surface distortion amount Δx(xₒ, t) at the same time, for each vehicle that passes over the bridge 200. The statistical processing unit 20 compares the deflection amount δ(xₒ, t) with the surface distortion amount ϵx(xₒ, t) at each time t, and calculates a correlation coefficient.

If points specified by the deflection amount δ(xₒ, t) and the surface distortion amount ϵx(xₒ, t) are plotted, the relationship between the point position and the degradation state of the bridge 200 is the same as that in the second and third example embodiments. That is to say, in the fourth example embodiment, the graphs in FIGS. 13(a) to 13(c) are applicable in which the difference Δδ in the deflection amount is replaced with the deflection amount δ, and the surface displacement amount Δx is replaced with the surface distortion amount ϵx.

Accordingly, if the slab is sound, or a shallow crack has occurred in the slab, the deflection amount δ(xₒ, t) and the surface distortion amount ϵx(xₒ, t) are proportional to each other, and all of the points specified by the deflection amount δ(xₒ, t) and the surface distortion amount ϵx(xₒ, t) are plotted on the same line regardless of time t (see FIG. 13(a)).

If cracks extending in one direction have occurred in the slab, the transmission of stress that occurs in the bridge 200 is inhibited by the cracks, and thus, the points specified by the deflection amount δ(xₒ, t) and the surface distortion amount ϵx(xₒ, t) are plotted at positions deviated from a line (see FIG. 13(b)).

Furthermore, if cracks extending in two directions have occurred in the slab, the transmission of the stress that occurs in the bridge 200 is further inhibited due to an increase in the number of cracks, and thus, the points specified by the deflection amount δ(xₒ, t) and the surface distortion amount ϵx(xₒ, t) are plotted at positions that are further deviated from a line.

In the fourth example embodiment as well, a correlation coefficient can be calculated by applying the deflection amount δ(xₒ, t) and the surface distortion amount ϵx(xₒ, t) to the above. Expression 18. In this case as well, the correlation coefficient takes a value that differs depending on the degradation state. Accordingly, it indicates that the degradation state of the bridge 200 can also be determined in the case of using the correlation coefficient of the deflection amount δ(xₒ, t) and the surface distortion amount ϵx(xₒ, t). Accordingly, in the fourth example embodiment as well, a look-up table is created while associating this correlation coefficient with the state of the bridge, and the degradation state determination unit 30 determines the degradation state using this look-up table.

### [Apparatus Operation]

Next, operations of the state determination apparatus according to the fourth example embodiment of the invention will be described with reference to FIG. 21. FIG. 21 is a flowchart showing operations of the state determination apparatus according to the fourth example embodiment of the invention. In the fourth example embodiment the state determination method is carried out by operating the state determination apparatus. Accordingly, the following description of the operations of the state determination apparatus replaces the description of the state determination method according to the fourth example embodiment.

As shown in FIG. 21, first, the measurement unit 10 acquires image data from the image capture device 50, and measures the deflection amount δ(xₒ, t) and the surface displacement amount Δx(xₒ, t) at the measurement position xₒ based on the acquired image data (step C1).

Next, the measurement unit 10 calculates the surface distortion amount ϵx(xₒ, t) at the measurement position xₒ using the measured surface displacement amount Δx(xₒt) (step C2).

Next, the preprocessing unit 40 records the deflection amount δ(xₒ, t) measured in step C1 and the surface distortion amount ϵx(xₒ, t) calculated in step C2 in association with the vehicle 230 that passes over the structure 200 during the measurement (step C3). Steps C1 to C3 are repeatedly performed until a sufficient volume of data is recorded.

Next, the statistical processing unit 20 calculates a correlation coefficient of the deflection amount Δδ(xₒ, t) and the surface distortion amount ϵx(xₒ, t) using the data recorded in step C3 (step C4).

Next, the degradation state determination unit 30 determines the degradation state of the bridge 200 by checking the correlation coefficient calculated in step C4 with a pre-created look-up table (step C5). Then, the degradation state determination unit 30 outputs the determination result to an external device.

### [Effects of Fourth Example Embodiment]

As described above, according to the fourth example embodiment, a correlation coefficient of the deflection amount δ(xₒ, t) and the surface distortion amount ϵx(xₒ, t) of the structure 200 is obtained, and the degradation state of the structure 200 is determined based on the correlation coefficient. Since the value of the correlation coefficient differs depending on the degradation state of the structure 200, the degradation state of the structure 200 can also be properly determined according to the fourth example embodiment.

Furthermore, according to the fourth example embodiment as well, the degradation state determination unit 30 can also learn the correspondence relationship between an index, such as a correlation coefficient, and the degradation state determination unit through machine learning to generate a learning model, and determine the degradation state determination unit using the generated learning model, similarly to the first example embodiment.

### [Program]

The program according to the fourth example embodiment need only be a program for causing a computer to perform steps C1 to C5 shown in FIG. 21. The state determination apparatus and the state determination method according to the fourth example embodiment can be realized by installing this program on a computer and executing the program. In this case, a CPU (Central Processing Unit) of the computer functions as the measurement unit 10, the statistical processing unit 20, the degradation state determination unit 30, and the preprocessing unit 40 and performs processing.

The program according to the fourth example embodiment may also be executed by a computer system that includes a plurality of computers. In this case, for example, each of the computers may function as any of the measurement unit 10, the statistical processing unit 20, the degradation state determination unit 30, and the preprocessing unit 40.

### First Example Application

A first example application of the first to fourth embodiments will now be described. In the first example application, the state determination apparatus includes a function of calculating at least two of the correlation coefficients described in the first to fourth example embodiments. Therefore, according to the first example application, the state determination apparatus can determine the degradation state of a structure in more detail using the two or more correlation coefficients.

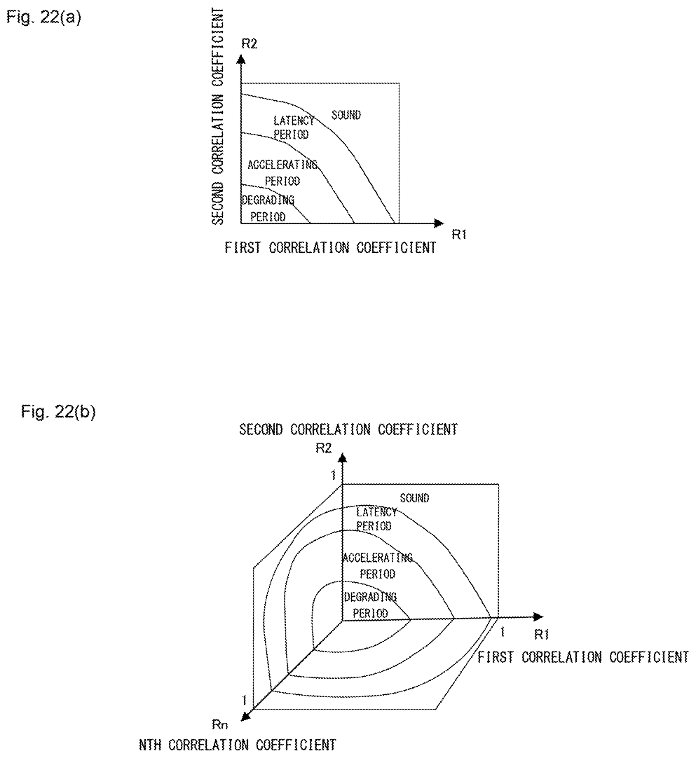

FIGS. 22(a) and 22(b) illustrate processing to determine the degradation state using, two or more correlation coefficients in the first application example of the example embodiments of the invention. FIG. 22(a) shows the case of using two correlation coefficients, and FIG. 22(b) shows the case of using three or more correlation coefficients.

In the example in FIG. 22(a), a two-dimensional graph with axes indicating two correlation coefficients R1 and R2 is set. In this graph, stepwise degradation stages are set based on the values of the correlation coefficients R1 and R2. The degradation state determination unit 30 specifies a preset degradation stage using the value of the correlation coefficient R1 and the value of the correlation coefficient R2.

In the example in FIG. 22(b), similarly, an n-dimensional graph with axes indicating n correlation coefficients R1, R2, and Rn is set. In this graph as well, stepwise degradation stages are set based on the value of the correlation coefficient R1, the value of the correlation coefficient R2, and the value of the correlation coefficient Rn. The degradation state determination unit 30 specifies a preset degradation stage using the value of the correlation coefficient R1, the value of the correlation coefficient R2, and the value of the correlation coefficient Rn.

In the examples in FIGS. 22(a) and 22(b), a sound period, a latency period an accelerating period, and a degrading period are set as the degradation stages. Note that the degradation stages are set as appropriate based on an experiment or the like. For example, the state shown in FIG. 12(a) is set as the sound period or the latency period. The state shown in FIG. 12(b) is set as the accelerating period. The state shown in FIG. 12(c) is set as the degrading period.

Thus, according to the first example application, the degradation state of a structure can be determined in more detail. Also, a relationship other than the correlation coefficients described in the above first to fourth example embodiments may also be used. For example, if a relationship that has been confirmed through an experiment exists as the relationship between the deflection amount and the surface displacement amount, the degradation state may be determined using this relationship.

### Example Application 2

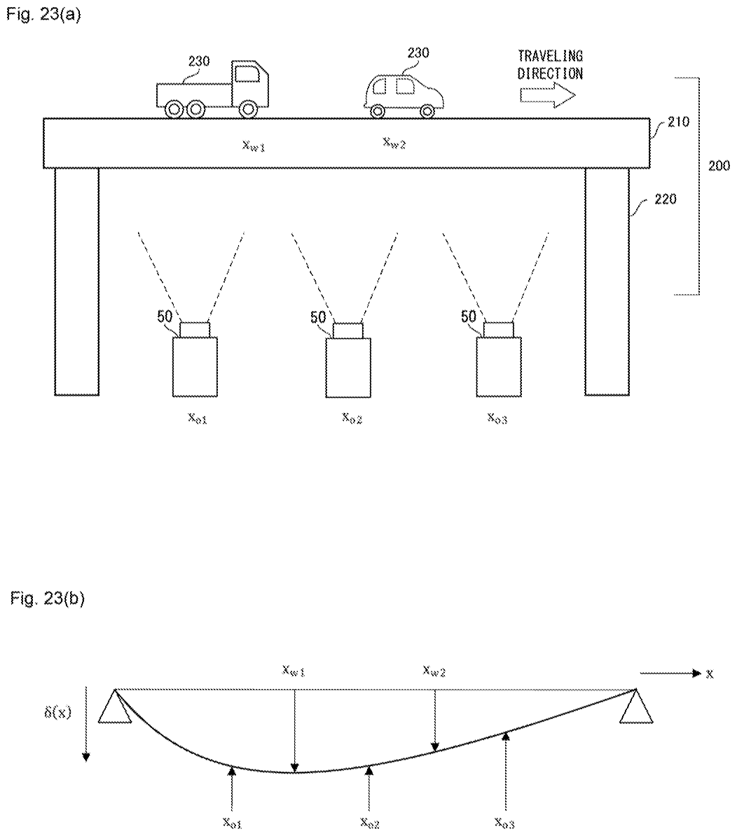

Next, a second example application of the first to fourth example embodiments will be described. FIG. 23(a) illustrates measurement of a deflection amount and a surface displacement amount of a bridge in the second application example of the example embodiments of the invention, and FIG. 23(b) shows a deflection curve of the bridge shown in FIG. 23(a).

As shown in FIG. 23(a), in the second example application, loads are applied to a plurality of portions of the bridge, and furthermore, the lower surface of the bridge is shot at a plurality of portions. Specifically, the loads applied to the bridge are applied at a load position x_{w1} and a load position x_{w2}, and furthermore, measurement is performed at three portions that are a measurement position xₒ₁, a measurement position xₒ₂, and a measurement position xₒ₃.

In this case, the deflection amount δ(x) is obtained by superposing the deflection amounts obtained using the above Expressions 15 and 16. Accordingly, the measurement unit 10 calculates the deflection amount with each of the image capture devices 50, and then superposes the calculated deflection amounts to calculate the deflection amount δ(x).

### Example Application 3

In the above first to fourth example embodiments, the degradation state based on cracks occurring on the bridge is determined, but the invention also makes it possible to determine the degradation state based on factors other than cracks, such as detachment or internal hollowing. This is because the correlation coefficients are also lowered due to these factors. Also, the degradation state determination unit 30 can perform determination while also giving consideration to whether or not cracks has occurred on the surface of the structure.

### Example Application 4

The above first to fourth example embodiments takes a vehicle traveling over a bridge as a load applied to a structure, but the invention is not limited thereto. The invention is also applicable to structures other than a bridge. Furthermore, a load that deflects a structure is not limited to being applied from above the structure.

### Others

In the image capture device 50 used in the first to fourth example embodiments, it is preferable that, for example, the lens focal length and the pixel pitch are set to 50 mm and 5 μm, respectively, and in this case, a pixel resolution of 500 μm can be achieved with an imaging distance of 5 m. An image sensor of the image capture device 50 may be a monochrome image sensor with a pixel number including 2000 pixels horizontal×2000 pixel vertical, and in this case, an image can be captured in a range of 1 m×1 m at an imaging distance of 5 m. The frame rate of the image sensor is set to 60 Hz, for example. Note that, in the image capture device 50, as well as the lens focal length, the pixel pitch, the pixel number, and the frame rate of the image sensor are set as appropriate as per an object to be measured.

In. the first to fourth example embodiments, the displacement detection unit 11 detects displacement through image correlation calculation, and in this case, displacement can, be estimated at a scale of 1/100 pixel as a minimum by means of sub-pixel displacement estimation through quadratic interpolation. In this case, a displacement resolution of 5 μm, can be achieved. Furthermore, in this case, the deflection amount calculation unit 12 can achieve a resolution of 10 μm in a normal direction. The displacement detection unit 11 can use a smoothing filter to reduce noise at the time of differentiation, during displacement differentiation. Furthermore, the displacement detection unit 11 can also detect displacement using a method other than image correlation calculation, such as optical flow calculation using a gradient method.

In the first to fourth example embodiments, the correlation coefficients are also lowered in the case where detachment and/or internal hollowing is present, in addition to the case of cracking, in the structure 200. For this reason, in the first example embodiment, the degradation state apparatus 100 may also determine whether or not detachment and/or internal hollowing is present, based on the correlation coefficient and whether or not cracking is present on the surface.

In the first to fourth example embodiments, descriptions have been given while taking a bridge as an example of a beam-shaped structure 200 and also taking a traveling vehicle as an example of a load applied to the structure 200, as described above. The first example embodiment has described the case Where a load is applied onto the beam-shaped structure 200. Note that, in the first example embodiment, cracking, internal hollowing, detachment, and degradation can be detected similarly in the case where a vehicle, which is a load, travels and moves on the bridge. Also, the first example embodiment is also applicable to structures of other materials, sizes, and shapes as long as the structures exhibit behavior similar to the above-described behavior in terms of the strength of materials, and is also applicable to a loading method other than a method of applying a load to the structure, e.g. a loading method of suspending a load.

### (Physical Configuration)

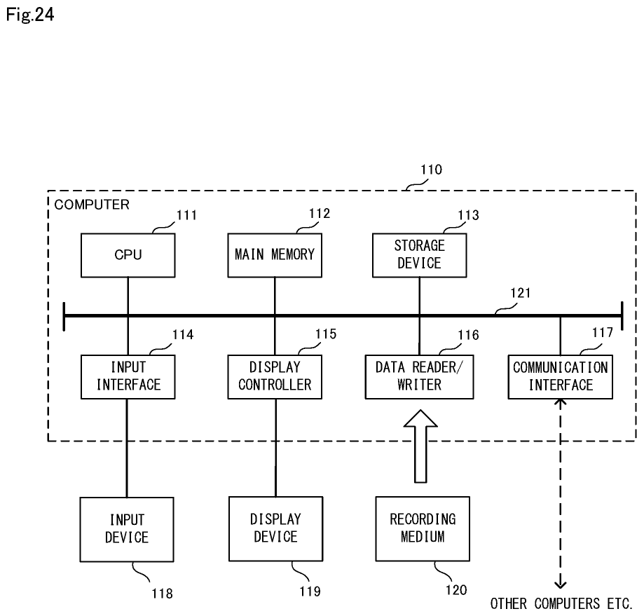

A description will now be given, with reference to FIG. 24, of a computer that realizes the degradation state determination apparatus by executing the program according to the first to fourth embodiments. FIG. 24 is a block diagram showing an example of a computer that realizes So the degradation state determination apparatus according to the first to fourth example embodiments of the invention.

As shown in FIG. 24, a computer 110 includes a CPU 111, a main memory 112, a storage device 113, an input interface 114, a display controller 115, a data reader/writer 116, and a communication interface 117. These units are connected to each other via a bus 121 so as to be able to communicate data. Note that the computer 110 may include GPU (Graphics Processing Unit) or an FPGA (Field-Programmable Gate Array) in addition to or in place of the CPU 111).

The CPU 111 loads the program (codes) according to these embodiments that are stored in the storage device 113 to the main memory 112 and executes the codes in a predetermined order, thereby performing various kinds of computation. The main memory 112 is typically a volatile storage device such as a DRAM (Dynamic Random Access Memory). The program according to these example embodiments is provided in a state of being stored in a computer-readable recording medium 120. Note that the program according to these example embodiments may also be distributed on the Internet to which the computer is connected via the communication to interface 117.

Specific examples of the storage device 113 may include a hard disk drive, a semiconductor storage device such as a flash memory, and the like. The input interface 114 mediates data transmission between the CPU 111 and input devices 118 such as a keyboard and a mouse. The display controller 115 is connected to a display device 119 and controls a display on the display device 119.

The data reader/writer 116 mediates data transmission between the CPU 111 and the recording medium 120, reads out the program from the recording medium 120, and writes, in the recording medium 120, the results of processing performed by the computer 110. The communication interface 117 mediates data transmission between the CPU 111 and other computers.

Specific examples of the recording medium 120 may include a general-purpose semiconductor storage device such as a CF (Compact Flash (registered trademark)) or an SD (Secure Digital), a magnetic recording medium such as a Flexible Disk, and an optical recording medium such as a CD-ROM (Compact Disk Read Only Memory).

The degradation state determination apparatus according to these example embodiments may also be realized using hardware that corresponds to each of the units, rather than a computer in which the program is installed. Furthermore, the degradation state determination apparatus may be partially realized by a program, and the remainder may be realized by hardware.

Part of, or the entire embodiment described above can be expressed by the following (Supplementary note 1) to (Supplementary note 18), but is not limited thereto.

### (Supplementary Note 1)

A state determination apparatus for determining a state of a structure, including
a measurement unit configured to measure a deflection amount and a surface displacement amount of the structure;
a statistical processing unit configured to perform statistical processing using the measured deflection amount and surface displacement amount; and
a degradation state determination unit configured to determine a degradation state of the structure based on a result of the statistical processing.

### (Supplementary Note 2)

The state determination apparatus according to Supplementary note 1,
wherein the statistical processing unit obtains a correlation coefficient of the deflection amount or a difference in the deflection amount and the surface displacement amount through the statistical processing and
the degradation state determination unit determines the degradation state of the structure based on the correlation coefficient.

### (Supplementary Note 3)

The state determination apparatus according to Supplementary note 2, further including:
a preprocessing unit configured to record the measured deflection amount or the difference in the deflection amount and the surface displacement amount in association with a measurement condition.

### (Supplementary Note 4)

The state determination apparatus according to Supplementary note 3,
wherein the preprocessing unit records the measured deflection amount or the difference in the deflection amount and the surface displacement amount in association with a load that has caused deflection, and
the statistical processing unit calculates the correlation coefficient using the deflection amount or the difference in the deflection amount and the surface displacement amount relative to each load that has caused deflection.

### (Supplementary Note 5)

The state determination apparatus according to any one of Supplementary notes 2 to 4,
wherein the statistical processing unit time-differentiates the deflection amount or the difference in the deflection amount and obtains a correlation coefficient of an obtained value and the surface displacement amount.

### (Supplementary Note 6)

The state determination apparatus according to any one of Supplementary notes 1 to 5,
wherein the measurement unit measures the deflection amount and the surface displacement amount of the structure using data that is optically obtained from the structure.

### (Supplementary Note 7)

A state determination method for determining a state of a structure, including:
(a) a step of measuring a deflection amount and a surface displacement amount of the structure;
(b) a step of performing statistical processing using the measured deflection amount and surface displacement amount; and
(c) a step of determining a degradation state of the structure based on a result of the statistical processing.

### (Supplementary Note 8)

The state determination method according to Supplementary note 7,
wherein, in the (b) step, a correlation coefficient of the deflection amount or a difference in the deflection amount and the surface displacement amount is obtained through the statistical processing, and
in the (c) step, the degradation state of the structure is determined based on the correlation coefficient.

### (Supplementary Note 9)

The state determination method according to Supplementary note 8, further including:
(d) a step of recording the measured deflection amount or the difference in the deflection amount and the surface displacement amount in association with a measurement condition.

### (Supplementary Note 10)

The state determination method according to Supplementary note 9,
wherein, in the (d) step, the measured deflection amount or the difference in the deflection amount and the surface displacement amount are recorded in association with a load that has caused deflection, and
in the (b) step, the correlation coefficient is calculated using the deflection amount or the difference in the deflection amount and the surface displacement amount relative'to each load that has caused deflection.

### (Supplementary Note 11)

The state determination method according to any one of Supplementary notes 8 to 10,
wherein, in the (b) step, the deflection amount or the difference in the deflection amount is time-differentiated, and a correlation coefficient of an obtained value and the surface displacement amount is obtained.

### (Supplementary Note 12)

The state determination method according to any one of Supplementary notes 7 to 11,
wherein, in the (a) step, the deflection amount and the surface displacement amount of the structure are measured using data that is optically obtained from the structure.

### (Supplementary Note 13)

A computer-readable recording medium that includes a program, for determining a state of a structure using a computer recorded thereon, the program including instructions that cause the computer to carry out:
(a) a step of measuring a deflection amount and a surface displacement amount of the structure;
(b) a step of performing statistical processing using the measured deflection amount and surface displacement amount; and
(c) a step of determining a degradation state of the structure based on a result of the statistical processing.

### (Supplementary Note 14)

The computer-readable recording medium according to Supplementary note 13,
wherein, in the (b) step, a correlation coefficient of the deflection'amount or a difference in the deflection amount and the surface displacement amount is obtained through the statistical processing, and
in the (c) step, the degradation state of the structure is determined based on the correlation coefficient.

### (Supplementary Note 15)

The computer-readable recording medium according to Supplementary note 14, the program further including instruction that cause the computer to carry out:
(d) a step of recording the measured deflection amount or the difference in the deflection amount and the surface displacement amount in association with a measurement condition,

### (Supplementary Note 16)

The computer-readable recording medium according to Supplementary note 15,
wherein, in the (d) step, the measured deflection amount or the difference in the deflection amount and the surface displacement amount are recorded in association with a load that has caused deflection, and
in the (b) step, the correlation coefficient is calculated using the deflection amount or the difference in the deflection amount and the surface displacement amount relative to each load that has caused deflection

### (Supplementary Note 17)

The computer-readable recording medium according to any one of Supplementary notes 14 to 16,
wherein, in the (b) step, the deflection amount or the difference in the deflection amount is time-differentiated, and a correlation coefficient of an obtained value and the surface displacement amount is obtained.

### (Supplementary Note 18)

The computer-readable recording medium according, to any one of Supplementary notes 13 to 17,
wherein, in the (a) step, the deflection amount and the surface displacement amount of the structure are measured using data that is optically obtained from the structure.

The invention is not limited to the above embodiments, and various modifications may be made within the scope of the invention described in the claims. These modifications are also encompassed in the scope of the invention.

The invention of the present application has been described above with reference to the example embodiments, but the invention of the present application is not limited to the above example embodiments. The configurations and the details of the invention of the present application can be changed in various manners that can be understood by a person skilled in the art within the scope of the invention of the present application.

This application is based upon and claims the benefit of priority from Japanese application No. 2017-174805 filed on Sep. 12, 2017, the disclosure of which is incorporated herein in its entirely by reference.

### INDUSTRIAL APPLICABILITY

As described above, according to the invention, the degradation state of a structure can be properly determined using both a deflection amount and a surface distortion of the structure. The invention is available in determination of degradation of an infrastructural structure.

### LIST OF REFERENCE SIGNS

10 Measurement unit
11 Displacement detection unit
12 Deflection amount calculation unit
13 Surface displacement amount calculation unit
20 Statistical processing unit
30 Degradation state determination unit
40 Preprocessing unit
50 Image capture device
100 State determination apparatus
110 Computer
111 CPU
112 Main memory
113 Storage device
114 Input interface
115 Display controller
116 Data reader/writer
117 Communication interface
118 Input device
119 Display device
120 Recording medium
121 Bus
200 Structure (bridge)
201, 202 Region
210 Slab
220 Bridge Order
230 Vehicle

1. A state determination apparatus for determining a state of a structure, comprising:
a measurement unit configured to measure a deflection amount and a surface displacement amount of the structure;
a statistical processing unit configured to perform statistical processing using the measured deflection amount and surface displacement amount; and
a degradation state determination unit configured to determine a degradation state of the structure based on a result of the statistical processing.

2. The state determination apparatus according to claim 1,
wherein the statistical processing unit obtains a correlation coefficient of the deflection amount or a difference in the deflection amount and the surface displacement amount through the statistical processing, and
the degradation state determination unit determines the degradation state of the structure based on the correlation coefficient.

3. The state determination apparatus according to claim 2, further comprising:
a preprocessing unit configured to record the measured deflection amount or the difference in the deflection amount and the surface displacement amount in association with a measurement condition.

4. The state determination apparatus according to claim 3,
wherein the preprocessing unit records the measured deflection amount or the difference in the deflection amount and the surface displacement amount in association with a load that has caused deflection, and
the statistical processing unit calculates the correlation coefficient using the deflection amount or the difference in the deflection amount and the surface displacement amount relative to each load that has caused deflection.

5. The state determination apparatus according to claim 2,
wherein the statistical processing unit time-differentiates the deflection amount or the difference in the deflection amount, and obtains a correlation coefficient of an obtained value and the surface displacement amount.

6. The state determination apparatus according to claim 1,
wherein the measurement unit measures the deflection amount and the surface displacement amount of the structure using data that is optically obtained from the structure.

7. A state determination method for determining a state of a structure, comprising:
a measuring a deflection amount and a surface displacement amount of the structure;
a performing statistical processing using the measured deflection amount and surface displacement amount; and
a determining a degradation state of the structure based on a result of the statistical processing.

8. A non-transitory computer-readable recording medium that includes a program for determining a state of a structure using a computer recorded thereon, the program including instructions that cause the computer to carry out:
a measuring a deflection amount and a surface displacement amount of the structure;
a performing statistical processing using the measured deflection amount and surface displacement amount; and
a determining a degradation state of the structure based on a result of the statistical processing.

9. The state determination method according to claim 7,
wherein, in the (b) step, a correlation coefficient of the deflection amount or a difference in the deflection amount and the surface displacement amount is obtained through the statistical processing, and
in the (c) step, the degradation state of the structure is determined based on the correlation coefficient.

10. The state determination method according to claim 9, further including:
(d) a step of recording the measured deflection amount or the difference in the deflection amount and the surface displacement amount in association with a measurement condition.

11. The state determination method according to claim 10,
wherein, in the (d) step, the measured deflection amount or the difference in the deflection amount and the surface displacement amount are recorded in association with a load that has caused deflection, and
in the (b) step, the correlation coefficient is calculated using the deflection amount or the difference in the deflection amount and the surface displacement amount relative to each load that has caused deflection.

12. The state determination method according to claim 9,
wherein, in the (b) step, the deflection amount or the difference in the deflection amount is time-differentiated, and a correlation coefficient of an obtained value and the surface displacement amount is obtained.

13. The state determination method according to claim 7,
wherein, in the (a) step, the deflection amount and the surface displacement amount of the structure are measured using data that is optically obtained from the structure.

14. The non-transitory computer-readable recording medium according to claim 8,
wherein, in the (b) step, a correlation coefficient of the deflection amount or a difference in the deflection amount and the surface displacement amount is obtained through the statistical processing, and
in the (c) step, the degradation state of the structure is determined based on the correlation coefficient.

15. The non-transitory computer-readable recording medium according to claim 14, the program further including instruction that cause the computer to carry out:
(d) a step of recording the measured deflection amount or the difference in the deflection amount and the surface displacement amount in association with a measurement condition.

16. The non-transitory computer-readable recording medium according to claim 15,
wherein, in the (d) step, the measured deflection amount or the difference in the deflection amount and the surface displacement amount are recorded in association with a load that has caused deflection, and
in the (b) step, the correlation coefficient is calculated using the deflection amount or the difference in the deflection amount and the surface displacement amount relative to each load that has caused deflection.

17. The non-transitory computer-readable recording medium according to claim 14,
wherein, in the (b) step, the deflection amount or the difference in the deflection amount is time-differentiated, and a correlation coefficient of an obtained value and the surface displacement amount is obtained.

18. The non-transitory computer-readable recording medium according to claim 8,
wherein, in the (a) step, the deflection amount and the surface displacement amount of the structure are measured using data that is optically obtained from the structure.
